(19) United States
(12) Patent Application Publication
(10) Pub. No.: US 2022/0198329 A1
(43) Pub. Date: Jun. 23, 2022

(54) INFORMATION PROCESSING APPARATUS, INFORMATION PROCESSING METHOD, AND INFORMATION PROCESSING PROGRAM

(71) Applicant: Actapio, Inc., East Wenatchee, WA (US)

(72) Inventor: Shinichiro OKAMOTO, Wenatchee, WA (US)

(21) Appl. No.: 17/518,506

(22) Filed: Nov. 3, 2021

Related U.S. Application Data
(60) Provisional application No. 63/127,792, filed on Dec. 18, 2020.

(51) Int. Cl. G06N 20/00

(52) U.S. Cl. CPC G06N 20/00; G06K 9/6227

(57) ABSTRACT

An information processing apparatus according to the application concerned includes an obtaining unit that obtains a dataset of training data to be used for the training of a model; and a generating unit that uses the dataset and generates a model in such a way that there is a decrease in the variability in the weight.

### TECHNICAL FIELD

The present invention is related to an information processing apparatus, an information processing method, and a non-transitory computer readable storage medium.

### BACKGROUND ART

In recent years, a technology has been proposed in which various types of models, such as an SVM (Support Vector Machine) and a DNN (Deep Neural Network), are trained in the features of the training data and are instructed to make a variety of predictions and classifications. As an example of such a training method, a technology has been proposed in which the training form of the training data is dynamically varied according to the values of hyperparameters.
[Patent Literature 1] Japanese Patent Application Laid-open No. 2019-164793

### DISCLOSURE OF INVENTION

### Problem to be Solved by the Invention

In the technology mentioned above, there is still room for enhancing the degree of accuracy of a model. For example, in the example explained above, it is nothing more than dynamically varying the training data, which represents the target features for training, according to the values of the hyperparameters. Thus, if the values of the hyperparameters are not appropriate, there are times when the degree of accuracy of the model cannot be enhanced. Hence, there is a demand for enhancing the degree of accuracy of a model by adjusting the parameters of the model itself instead of adjusting the hyperparameters.

### Means for Solving Problem

An information processing apparatus according to the application concerned includes an obtaining unit that obtains a dataset of training data to be used for the training of a model; and a generating unit that uses the dataset and generates a model in such a way that there is a decrease in the variability in the weight.

### Effect of the Invention

According to an aspect of the embodiments, it becomes possible to enhance the degree of accuracy of a model.

### BRIEF DESCRIPTION OF DRAWINGS

FIG. 1 is a diagram illustrating an example of an information processing system according to an embodiment.

FIG. 2 is a diagram for explaining an exemplary flow of model generation performed using an information processing apparatus according to the embodiment.

FIG. 3 is a diagram illustrating an exemplary configuration of the information processing apparatus according to the embodiment.

FIG. 4 is a diagram illustrating an example of the information registered in a training data database according to the embodiment.

FIG. 5 is a diagram illustrating an example of the information registered in a model generation database according to the embodiment.

FIG. 6 is a flowchart for explaining an exemplary flow of information processing performed according to the embodiment.

FIG. 7 is a sequence diagram illustrating the sequence of operations performed in the information processing system according to the embodiment.

FIG. 8 is a diagram illustrating the concept of a first operation according to the embodiment.

FIG. 9 is a diagram illustrating the concept of a second operation according to the embodiment.

FIG. 10 is a diagram illustrating the concept of a third operation according to the embodiment.

FIG. 11 is a diagram illustrating the data used in an experiment.

FIG. 12 is a diagram illustrating a list indicating a first experimental result.

FIG. 13 is a diagram illustrating a graph related to the first experimental result.

FIG. 14 is a diagram illustrating a graph related to the first experimental result.

FIG. 15 is a diagram illustrating graphs related to the first experimental result.

FIG. 16 is a diagram illustrating a list indicating a second experimental result.

FIG. 17 is a diagram illustrating a graph related to the second experimental result.

FIG. 18 is a diagram illustrating a graph related to the second experimental result.

FIG. 19 is a diagram illustrating graphs related to the second experimental result.

FIG. 20 is a diagram illustrating the data used in an experiment.

FIG. 21 is a diagram illustrating a list indicating a third experimental result.

FIG. 22 is a diagram illustrating a graph related to the third experimental result.

FIG. 23 is a diagram illustrating a graph related to the third experimental result.

FIG. 24 is a diagram illustrating a graph related to the third experimental result.

FIG. 25 is a diagram illustrating a list indicating a fourth experimental result.

FIG. 26 is a diagram illustrating a graph related to the fourth experimental result.

FIG. 27 is a diagram illustrating a graph related to the fourth experimental result.

FIG. 28 is a diagram illustrating graphs related to the fourth experimental result.

FIG. 29 is a diagram illustrating a list indicating a fifth experimental result.

FIG. 30 is a diagram illustrating a graph related to the fifth experimental result.

FIG. 31 is a diagram illustrating a graph related to the fifth experimental result.

FIG. 32 is a diagram illustrating graphs related to the fifth experimental result.

FIG. 33 is a diagram illustrating a list indicating a sixth experimental result.

FIG. 34 is a diagram illustrating a graph related to the sixth experimental result.

FIG. 35 is a diagram illustrating a graph related to the sixth experimental result.

FIG. 36 is a diagram illustrating an exemplary hardware configuration.

### BEST MODE(S) OF CARRYING OUT THE INVENTION

An illustrative embodiment (hereinafter, called “embodiment”) of an information processing apparatus, an information processing method, and a non-transitory computer-readable storage medium having stored therein an information processing program is described below in detail with reference to the accompanying drawings. However, the information processing apparatus, the information processing method, and the information processing program are not limited by the embodiment described below. Meanwhile, embodiments can be appropriately combined without causing any contradictions in the operation details. Moreover, in the embodiments, identical constituent elements are referred to by the same reference numerals, and their explanation is not repeated.

### Embodiment

In the embodiment described below, the explanation is given about three operations (a first operation, a second operation, and a third operation) meant for reducing the variability in the weight that represents a parameter of a model; and experimental results regarding achieving enhancement in the degree of accuracy of a model by reducing the variability in the weight are presented and explained. In the embodiment, the standard deviation is used as an example of the index indicating the variability. However, as long as the index indicates the variability, some other index such as dispersion can also be used. Although explained later in detail, as a result of reducing the variability in the weight of the model by performing, for example, the first operation, the second operation, or the third operation; it is believed that the output of the model (the inference result of classification) becomes more natural. In this way, the increased naturalness in the output of the model is believed to lead to the enhancement in the degree of accuracy of the model. In the present embodiment, before presenting the abovementioned three operations and the experimental results, firstly the explanation is given about a configuration of an information processing system 1 that generates a model, and about the training of a model.

### 1. Configuration of Information Processing System

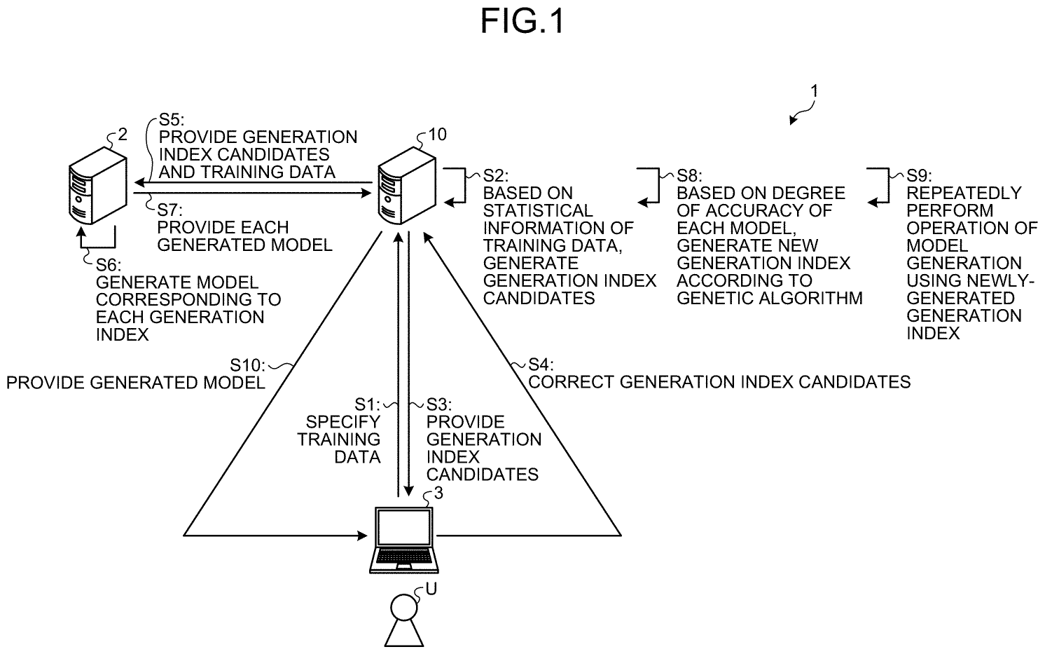

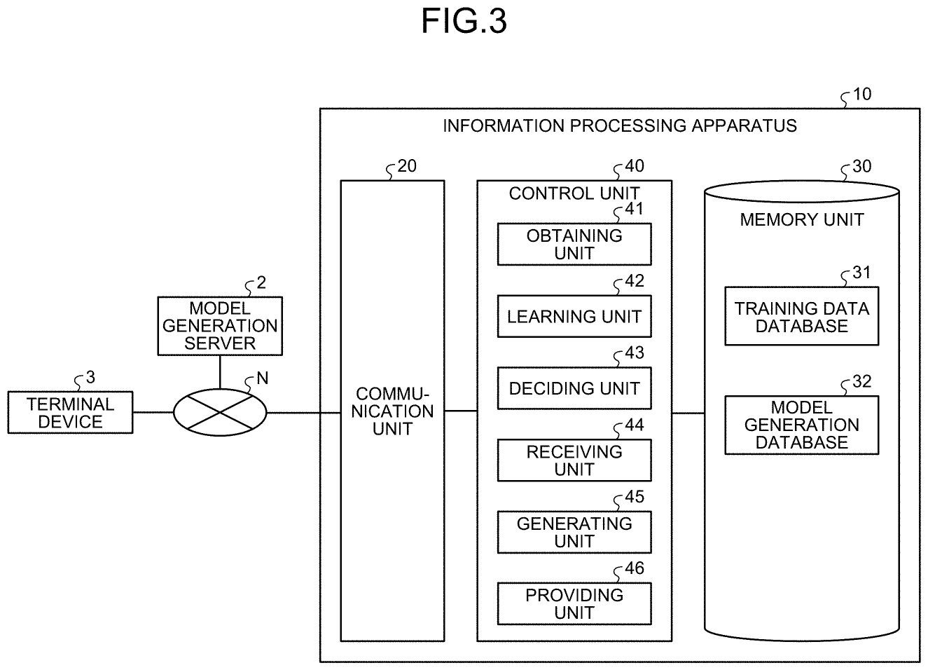

Firstly, explained below with reference to FIG. 1 is a configuration of an information processing system that includes an information processing apparatus 10 representing an example of an information processing apparatus. FIG. 1 is a diagram illustrating an example of the information processing system according to the embodiment. As illustrated in FIG. 1, the information processing system 1 includes the information processing apparatus 10, a model generation server 2, and a terminal device 3. Meanwhile, the information processing system 1 can include a plurality of model generation servers 2 or a plurality of terminal devices 3. The information processing apparatus 10 and the model generation server 2 can be implemented using the same server device or the same cloud system. The information processing apparatus 10, the model generation server 2, and the terminal device 3 are communicably connected to each other in a wired manner or in a wireless manner via a network N (refer to FIG. 3).

The information processing apparatus 10 is an information processing apparatus that performs an index generation operation for generating a generation index that represents an index to be used in the generation of a model (i.e., represents the recipe of the model); performs a model generation operation for generating a model according to the generation index; and provides the generation index and the model. The information processing apparatus 10 is implemented using, for example, a server device or a cloud system.

The model generation server 2 is an information processing apparatus that generates a model which is trained in the features of the training data; and is implemented using, for example, a server device or a cloud system. For example, when a config file indicating the type and the actions of a model to be generated and indicating the manner of implementing the training of the features of the training data is received as the generation index of the model; the model generation server 2 performs automatic generation of the model according to the received config file. Meanwhile, the model generation server 2 can learn a model using an arbitrary model training method. Moreover, for example, the model generation server 2 can be one of various types of existing services such as AutoML (Automated Machine Learning).

The terminal device 3 is a terminal device used by a user U; and is implemented using, for example, a PC (Personal Computer) or a server device. For example, the terminal device 3 instructs generation of the generation index of a model by performing communication with the information processing apparatus 10, and obtains the model generated by the model generation server 2 according to the generation index.

### 2. Overview of Operations Performed in Information Processing Apparatus 10

Given below is the explanation about the overview of the operations performed in the information processing apparatus 10. Firstly, the information processing apparatus 10 receives an indication from the terminal device 3 about such training data which has features in which a model is to be trained (Step S1). For example, the information processing apparatus 10 stores, in a predetermined memory device, a variety of training data to be used for training; and receives, from the user U, the specification of the training data to be used. Meanwhile, for example, the information processing apparatus 10 can obtain the training data, which is to be used for training, from the terminal device 3 or from various types of external servers.

Herein, arbitrary data can be used as the training data. For example, the information processing apparatus 10 can treat, as the training data, a variety of information related to the users, such as the location history of each user, the history of the web contents browsed by each user, the buying history of each user, or the history of search queries issued by each user. Alternatively, the information processing apparatus 10 can treat, as the training data, the demographic attributes or the psychographic attributes of the users. Still alternatively, the information processing apparatus 10 can treat, as the training data, metadata such as the types, the details, and the creators of various web contents to be delivered.

In such a case, based on the statistical information of the training data to be used for training, the information processing apparatus 10 generates generation index candidates (Step S2). For example, the information processing apparatus 10 generates generation index candidates that indicate which type of model is to be trained according to which training method. In other words, the information processing apparatus 10 generates, as a generation index, a model that can be accurately trained in the features of the training data, or a training method for accurately training a model in the features of the training data. That is, the information processing apparatus 10 optimizes the training method. Meanwhile, regarding the generation index to be generated in response to the selection of a particular type of training data, the explanation is given later.

Then, the information processing apparatus 10 provides the generation index candidates to the terminal device 3 (Step S3). In that case, the user U corrects the generation index candidates according to the liking or the empirical rules (Step S4). Subsequently, the information processing apparatus 10 provides the generation index candidates and the training data to the model generation server 2 (Step S5).

On the other hand, the model generation server 2 generates a model corresponding to each generation index (Step S6). For example, the model generation server 2 trains a model, which has the structure indicated by a generation index, in the features of the training data according to the training method indicated by the generation index. Then, the model generation server 2 provides each generated model to the information processing apparatus 10 (Step S7).

Each model generated by the model generation server 2 is believed to have a different degree of accuracy attributed to the differences in the corresponding generation index. In that regard, based on the degree of accuracy of each model, the information processing apparatus 10 generates a new generation index according to a genetic algorithm (Step S8), and repeatedly performs the operation of model generation using the newly-generated generation index (Step S9).

For example, the information processing apparatus 10 divides the training data into data for evaluation and data for training; and obtains a plurality of models that is trained in the features of the data for training and that is generated according to mutually different generation indexes. For example, the information processing apparatus 10 generates 10 generation indexes, and generates 10 models using the 10 generation indexes and using the data for training. In such a case, the information processing apparatus 10 predicts the degree of accuracy of each of the 10 models using the data for evaluation.

Then, from among the 10 models, the information processing apparatus 10 selects a predetermined number of models (for example, five) in descending order of degrees of accuracy. Subsequently, from the generation indexes used in generating the selected five models, the information processing apparatus 10 generates new generation indexes. For example, the information processing apparatus 10 treats the generation indexes as individual entities in a genetic algorithm, and treats the following as the as genes in the genetic algorithm: the types of the models indicated by the generation indexes, the structures of the models indicated by the generation indexes, and various types of training methods (i.e., various types of indexes indicated by the generation indexes). Then, the information processing apparatus 10 selects the individual entities for the purpose of gene crossover and then performs gene crossover, and thus generates 10 new generation indexes of the next generation. Meanwhile, at the time of performing gene crossover, the information processing apparatus 10 can also take mutation into account. Moreover, the information processing apparatus 10 can also perform two-point crossover, multipoint crossover, uniform crossover, and random selection of genes serving as the crossover targets. Furthermore, the information processing apparatus 10 can adjust the crossover rate during crossover in such a way that the genes of individual entities having high degrees of model accuracy are proportionally carried over to the individual entities of the next generation.

Moreover, the information processing apparatus 10 again generates 10 new models using the generation indexes of the next generation. Then, based on the degrees of accuracy of the 10 new models, the information processing apparatus 10 generates new generation indexes according to the genetic algorithm mentioned above. As a result of repeatedly performing such operations, the information processing apparatus 10 can bring the generation indexes closer to be appropriate for the features of the training data, that is, can bring the generation indexes closer to the optimized generation indexes.

Meanwhile, when predetermined conditions are satisfied, such as when a predetermined number of new generation indexes are generated or when the maximum value, the average value, or the minimum value of the degree of accuracy of the models exceeds a threshold value; the information processing apparatus 10 selects the model having the highest degree of accuracy as the model to be provided. Then, the information processing apparatus 10 provides the selected model and the corresponding generation index to the terminal device 3 (Step S10). As a result of performing such operations, in response to only the selection of the training data by the user, the information processing apparatus 10 can generate the generation index of the appropriate model and can provide the model conforming to that generation index.

In the example given above, the information processing apparatus 10 implements stepwise optimization of the generation indexes using a genetic algorithm. However, the embodiment is not limited to that example. As made clear in the following explanation, the degree of accuracy of a model not only varies according to the actual features of the model such as the type and the structure, but also varies significantly according to the index used at the time of generating the model (i.e., the indexes used at the time of training the features of the training data), such as according to the type of the training data input to the model or according to the types of hyperparameters used in the training of the model.

In that regard, if the generation index estimated to be the most suitable is to be generated according to the training data, then the information processing apparatus 10 need not perform optimization using the genetic algorithm. For example, the information processing apparatus 10 can present, to the user, the generation index that is generated according to whether or not the training data satisfies various conditions generated according to empirical rules, and can generate a model according to the presented generation index. Moreover, if any correction of the presented generation index is received, then the information processing apparatus 10 can generate a model according to the corrected generation index; present the degree of accuracy of the generated model to the user; and can again receive correction of the generation model. That is, the information processing apparatus 10 can enable the user to achieve the optimized generation index by the trial-and-error method.

### 3. Regarding Generation of Generation Indexes

Given below is the explanation about an example about which type of generation index is to be generated for which type of training data. The following explanation is only exemplary; and, as long as the generation index is generated according to the features of the training data, any arbitrary operations can be performed.

[3-1. Regarding Generation Indexes]

Firstly, given below is the explanation of an example of the information indicating the generation index. For example, in the case of training a model in the features of the training data; the form at the time of inputting the training data to the model, the form of the model, and the training form of the model (i.e., the features indicated by the hyperparameters) are believed to be the factors contributing to the degree of accuracy of the eventually-obtained model. In that regard, according to the features of the training data, the information processing apparatus 10 generates the generation index in which each form is optimized, and thus enhances the degree of accuracy of the model.

For example, the training data is believed to contain data having various labels assigned thereto, that is, contain data exhibiting various features. However, when the data exhibiting features that are not useful in data classification is treated as the training data, there is a risk of a decline in the degree of accuracy in the eventually-obtained model. In that regard, as far as the form at the time of inputting the training data to a model is concerned, the information processing apparatus 10 decides on the features of the training data to be input. For example, from among the training data, the information processing apparatus 10 decides on the data assigned with a particular label (i.e., the data having particular features) as the data to be input. In other words, the information processing apparatus 10 optimizes the combination of the features to be input.

Moreover, the training data is believed to contain columns of various formats, such as data having only numerical values and data containing character strings. At the time of inputting such training data to a model, it is believed that the degree of accuracy of the model changes depending on whether the training data is input without modification or whether the training data is converted into data some other format. For example, at the time of inputting training data of a plurality of types (sets of training data exhibiting mutually different features) such as training data of character strings and training data of numerical values, it is believed that the degree of accuracy of the model changes in each of the following cases: when character strings and numerical values are input without modification; when character strings are converted into numerical values and only numerical values are input; and when numerical values are input by treating them as character strings. In that regard, the information processing apparatus 10 decides on the format of the training data to be input to the model. For example, the information processing apparatus 10 decides on whether to use numerical values or character strings as the training data to be input to the model. In other words, the information processing apparatus 10 optimizes the column type of the features to be input.

Meanwhile, when sets of training data exhibiting mutually different features are present, the degree of accuracy of the model is believed to change depending on the combination of the features that are simultaneously input. That is, when sets of training data exhibiting mutually different features are present, the degree of accuracy of the model is believed to change according to the combination of the features that are trained (i.e., depending on the relationship of a plurality of features in a combination). For example, when training data exhibiting a first feature (for example, gender), training data exhibiting a second feature (for example, address), and training data exhibiting a third feature (for example, buying history) is present; the degree of accuracy of the model is believed to change depending on whether the training data exhibiting the first feature and the training data exhibiting the second feature is simultaneously input or whether the training data exhibiting the first feature and the training data exhibiting the third feature is simultaneously input. In that regard, the information processing apparatus 10 optimizes the combination (cross feature) of the features having the relationship in which the model is to be trained.

Herein, in various types of models, the input data is projected into the space of a predetermined dimensionality that is divided by a predetermined hyperplane, and the input data is classified according to the space in which the projected position belongs from among the divided space. For example, if the space in which the input data is projected has the number of dimensions to be smaller than the most suitable number of dimensions, then the classification capability of the input data undergoes a decline and thus the degree of accuracy of the model deteriorates. On the other hand, if the space in which the input data is projected has the number of dimensions to be greater than the most suitable number of dimensions, then the inner product with the hyperplane undergoes a change and thus there is a risk that the data different than the data used at the time of training cannot be appropriately classified. In that regard, the information processing apparatus 10 optimizes the number of dimensions of the input data to be input to the model. For example, the information processing apparatus 10 controls the number of nodes in the input layer of the model, and optimizes the number of dimensions of the input data. In other words, the information processing apparatus 10 optimizes the number of dimensions of the space in which the input data is to be embedded.

Meanwhile, apparat from being an SVM, a model can be a neural network having a plurality of intermediate layers (hidden layers). Moreover, such a neural network can be one of various known types of neural networks such as a forward-type DNN in which information is transmitted in only one way from the input layer to the output layer; a convolutional neural network (CNN) in which convolution of information is performed in the intermediate layers; a recurrent neural network (RNN) having directional closed paths; and a Boltzmann machine. Moreover, various types of such a neural network include an LSTM (Long short-term memory) and some other types.

In this way, when there are different types of the model that is to be trained in various features of the training data, it is believed that the degree of accuracy of the model changes. In that regard, the information processing apparatus 10 selects that type of the model which is estimated to be accurately trained in the features of the training data. For example, the information processing apparatus 10 selects the type of the model according to the type of the label assigned to the training data. As more specific examples, when there is data to which a term related to “history” is assigned as the label, the information processing apparatus 10 selects an RNN believed to be trainable in the features of the history in a better way; and, when there is data to which a term related to “image” is assigned as the label, the information processing apparatus 10 selects a CNN believed to be trainable in the features of images in a better way. Apart from that, the information processing apparatus 10 can determine whether or not the label is a prespecified term or a term similar to a prespecified term, and can select the type of the model associated in advance to the same term or a term determined to be similar.

Meanwhile, when there is a change in the number of intermediate layers of a model or when there is a change in the number of nodes included in a single intermediate layer, it is believed that the training accuracy of the model undergoes a change. For example, if a model has a large number of intermediate layers (if a model is deep), it is believed that the classification can be performed according to more abstract features. On the other hand, since the local error in backpropagation becomes difficult to propagate till the input layer, there is a risk that the training cannot be appropriately performed. Moreover, if an intermediate layer has a small number of nodes, it becomes possible to achieve more sophisticated abstraction. However, if the number of nodes is too small, it is highly likely that the information required in classification is lost. In that regard, the information processing apparatus 10 optimizes the number of intermediate layers or optimizes the number of nodes included in an intermediate layer. That is, the information processing apparatus 10 optimizes the architecture of the model.

Meanwhile, depending on the presence or absence of attention, or depending on whether or not there is autoregression in the nodes included in a model, or depending on which nodes are to be connected; it is believed that the degree of accuracy of the nodes changes. In that regard, the information processing apparatus 10 performs network optimization, such as whether or not to have autoregression and which nodes to connect.

Moreover, in the case of performing training for a model, the model optimization method (i.e., the algorithm used for training), the dropout rate, the node activation function, and the unit count are set as hyperparameters. Thus, also when there is a change in such hyperparameters, it is believed that the degree of accuracy of the model changes. In that regard, the information processing apparatus 10 optimizes the training form at the time of training of the model, that is, optimizes the hyperparameters.

Furthermore, also when the size of the model (i.e., the number of layers including the input layer, the intermediate layers, and the output layer; or the number of nodes) changes, the degree of accuracy of the model changes. In that regard, the information processing apparatus 10 also optimizes the size of the model.

In this way, the information processing apparatus 10 performs optimization regarding the indexes used at the time of generating various types of models as explained above. For example, the information processing apparatus 10 stores in advance the conditions corresponding to each index. Such conditions are set according to, for example, the empirical rules such as the degrees of accuracy of various types of models from the past training models. Then, the information processing apparatus 10 determines whether or not the training data satisfies each condition and adapts, as the generation indexes (or as the generation index candidates), the indexes that are associated in advance to the conditions either satisfied or not satisfied by the training data. As a result, the information processing apparatus 10 becomes able to generate the generation indexes that can be accurately trained in the features of the training data.

Meanwhile, as explained above, when a generation index is automatically generated from the training data and when the operation of creating a model according to the generation index is automatically performed, the user need not look into the training data and determine the distribution of the data. As a result, the information processing apparatus 10 enables achieving reduction in the time and efforts required by, for example, a data scientist to recognize the training data accompanying the creation of a model, and enables prevention of damage to the privacy accompanying recognition of the training data.

[3-2. Generation Index Corresponding to Data Type]

Given below is the explanation of an example of the conditions meant for generating a generation index. Firstly, the explanation is given about an example of the conditions corresponding to the type of data adapted as the training data.

For example, the training data used for training contains integers, floating decimal points, or character strings as data. Hence, when an appropriate model is selected with respect to the input data, the training accuracy of the model is estimated to become higher. In that regard, the information processing apparatus 10 generates a generation index based on whether the training data contains integers, or floating decimal points, or character strings.

For example, when the training data contains integers, the information processing apparatus 10 generates a generation index based on the continuity of the training data. For example, when the density of the training data exceeds a predetermined first threshold value, the information processing apparatus 10 treats the training data as data having continuity, and generates a generation index based on whether or not the maximum value of the training data exceeds a predetermined second threshold value. On the other hand, when the density of the training data is lower than the predetermined first threshold value, the information processing apparatus 10 treats the training data as sparse training data, and generates a generation index based on whether or not the number of unique values in the training data exceeds a predetermined third threshold value.

A more specific example is explained below. In the example given below, the explanation is given about an operation in which, of the config file sent to the model generation server 2 that automatically generates models according to AutoML, a feature function is selected as the generation index. For example, when the training data contains integers, the information processing apparatus 10 determines whether or not the density of the training data exceeds a predetermined first threshold value. For example, the information processing apparatus 10 calculates, as the density, the value obtained by dividing the number of unique values, from among the values included in the training data, by a value obtained by adding “1” to the maximum value of the training data.

If the density exceeds the predetermined first threshold value, the information processing apparatus 10 determines that the training data has continuity, and determines whether or not the value obtained by adding “1” to the maximum value of the training data exceeds a second threshold value. If the value obtained by adding “1” to the maximum value of the training data exceeds the second threshold value, then the information processing apparatus 10 selects “Categorical_collum_with_identity & embedding_column” as the feature function. On the other hand, if the value obtained by adding “1” to the maximum value of the training data is smaller than the second threshold value, then the information processing apparatus 10 selects “Categorical_column_with_identity” as the feature function.

On the other hand, if the density is lower than the predetermined first threshold value, then the information processing apparatus 10 determines that the training data is sparse, and determines whether or not the number of unique values included in the training data exceeds a predetermined third threshold value. If the number of unique values included in the training data exceeds the predetermined third threshold value, then the information processing apparatus 10 selects “Categorical_column_with_hash_bucket & embedding_column” as the feature function. On the other hand, if the number of unique values included in the training data is smaller than the predetermined third threshold value, then the information processing apparatus 10 selects “Categorical_column_with_hash_bucket” as the feature function.

When the training data contains character strings, the information processing apparatus 10 generates a generation index based on the number of types of character strings included in the training data. For example, the information processing apparatus 10 counts the number of unique character strings (the number of unique sets of data) included in the training data and, if the counted number is smaller than a predetermined fourth threshold value, selects “categorical_column_with_vocabulary_list and/or categorical_column_with_vocabulary_file” as the feature function. However, if the counted number is greater than is smaller than a fifth threshold value that is greater than the predetermined fourth threshold value, then the information processing apparatus 10 selects “categorical_column_with_vocabulary_file & embedding_column” as the feature function. On the other hand, if the counted number exceeds the fifth threshold value that is greater than the predetermined fourth threshold value, the information processing apparatus 10 selects “categorical_column_with_hash_bucket & embedding_column” as the feature function.

When the training data contains floating decimal points, the information processing apparatus 10 generates, as a generation index of a model, a conversion index for converting the input data to the model into training data. For example, the information processing apparatus 10 selects “bucketized_column” or “numeric_column”. That is, the information processing apparatus 10 bucketizes (performs grouping of) the training data and selects whether the bucket numbers are to be input or whether the actual numerical values are to be input. Moreover, for example, the information processing apparatus 10 can bucketize the training data in such a way that the range of numerical values associated to each bucket is approximately same. For example, the information processing apparatus 10 can associate the range of numerical values with respect to each bucket in such a way that the number of sets of training data classified in each bucket is approximately same. Meanwhile, alternatively, the information processing apparatus 10 can select either the number of buckets or the range of numerical values associated to the buckets as the generation index.

Moreover, the information processing apparatus 10 obtains the training data exhibiting a plurality of features and generates, as the generation index of the model, a generation index indicating the features in which the model is to be trained from among the features of the training data. For example, the information processing apparatus 10 decides that the training data having a particular label is to be input to the model, and generates a generation index indicating the decided label. Moreover, the information processing apparatus 10 generates, as the generation index of the model, a generation index indicating a plurality of types of training data, from among the types of training data, having the correlation in which the model is to be trained. For example, the information processing apparatus 10 decides on the combination of the labels to be simultaneously input to the model, and generates a generation index indicating the decided combination.

Moreover, the information processing apparatus 10 generates, as the generation index of the model, a generation index indicating the number of dimensions of the training data to be input to the model. For example, the information processing apparatus 10 can decide on the number of nodes in the input layer of the model according to the following: the number of sets of unique data included in the training data or the number of labels to be input to the model; the combination of the number of labels to be input to the model; and the number of buckets.

Moreover, the information processing apparatus 10 generates, as the generation index of the model, a generation index indicating the type of the model to be trained in the features of the training data. For example, according to the density or the sparseness of the training data used for training in the past, according to the details of the labels, according to the number of labels, and according to the number of combinations of the labels; the information processing apparatus 10 decides on the type of the model to be generated, and then generates a generation index indicating the decided type. For example, the information processing apparatus 10 generates a generation index indicating “BaselineClassifier”, “LinearClassifier”, “DNNClassifier”, “DNNLinearCombinedClassifier”, “BoostedTreesClassifier”, “AdaNetClassifier”, “RNNClassifier”, “DNNResNetClassifier”, or “AutoIntClassifier” as the class of the model in AutoML.

Meanwhile, the information processing apparatus 10 can generate a generation index indicating a variety of types of independent variables of the model of each class. For example, the information processing apparatus 10 can generate, as the generation index of the model, a generation index indicating the number of intermediate layers in the model or indicating the number of nodes included in each layer. Moreover, the information processing apparatus 10 can generate, as the generation index of the model, a generation index indicating the connection form among the nodes of the model or a generation index indicating the size of the model. These independent variables are appropriately selected depending on whether or not various statistical features of the training data satisfy predetermined conditions.

Moreover, the information processing apparatus 10 can generate, as the generation index of the model, a generation index indicating the training form by which the model is trained in the features of the training data, that is, a generation index indicating a hyperparameter. For example, the information processing apparatus 10 can generate a generation index indicating “stop_if_no_decrease_hook”, “stop_if_no_increase_hook”, “stop_if_higher_hook”, or “stop_if_lower_hook” in the training form setting in AutoML.

That is, based on the label of the training data to be used for training and based on the features of the actual data, the information processing apparatus 10 generates a generation index indicating the features of the training data in which the model is to be trained, the form of the model to be generated, and the training form at the time of training the model in the features of the training data. More particularly, the information processing apparatus 10 generates a config file meant for controlling the generation of a model in AutoML.

[3-3. Regarding Order of Deciding on Generation Index]

Herein, regarding the various types of indexes explained above, the information processing apparatus 10 can optimize the indexes either in parallel or in an appropriate order. Moreover, the information processing apparatus 10 can vary the order for optimizing the indexes.

That is, the information processing apparatus 10 can receive, from the user, the specification about the features of the training data in which the model is to be trained, about the form of the model to be generated, and about the sequence of deciding on the training form at the time of training the model in the features of the training data; and can decide on the indexes according to the received order.

For example, at the start of the generation of generation indexes, the information processing apparatus 10 optimizes the input features such as the features of the training data to be input and the form in which the training data is to be input; and then optimizes the input cross features such as the combination of the features for training. Subsequently, the information processing apparatus 10 selects a model and optimizes its structure. Then, the information processing apparatus 10 optimizes the hyperparameters, and ends the generation of generation indexes.

Herein, in the input feature optimization, the information processing apparatus 10 can perform repeated optimization of the input features by performing selection and correction of various input features such as the features of the training data to be input and the input form, and by performing selection of new input features using a genetic algorithm. In an identical manner, in the input cross feature optimization, the information processing apparatus 10 can perform repeated optimization of the input cross features, or can perform repeated selection of a model and optimization of the model structure. Moreover, the information processing apparatus 10 can perform repeated optimization of hyperparameters. Furthermore, the information processing apparatus 10 can repeatedly perform a series of operations such as input feature optimization, input cross feature optimization, model selection, model structure optimization, and hyperparameter optimization; and optimize each index.

Moreover, for example, the information processing apparatus 10 can optimize hyperparameters before selecting a model and optimizing the model structure; or can select a model and optimize the model structure before optimizing the input features or optimizing the input cross features. Furthermore, for example, the information processing apparatus 10 performs repeated optimization of input features, and then performs repeated optimization of input cross features. Subsequently, the information processing apparatus 10 can repeatedly perform input feature optimization and input cross feature optimization. In this way, regarding the sequence of optimization of the indexes and regarding the optimization operations to be performed in a repeated manner, arbitrary settings can be adapted.

[3-4. Regarding Flow of Model Generation in Information Processing Apparatus]

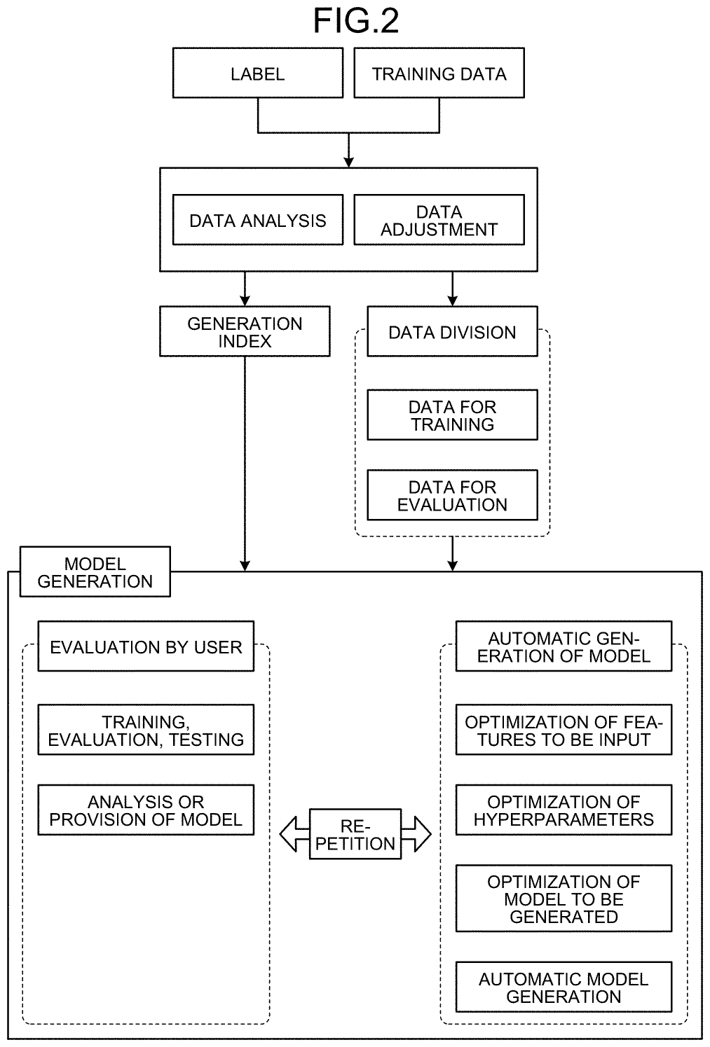

Given below is the explanation of an exemplary flow of the model generation performed using the information processing apparatus 10. FIG. 2 is a diagram for explaining an exemplary flow of the model generation performed using the information processing apparatus according to the embodiment. For example, the information processing apparatus 10 receives sets of training data and the label of each set of training data. Meanwhile, the information processing apparatus 10 can receive specification of training data and receive labels along with the specification.

In such a case, the information processing apparatus 10 analyzes the data and performs data adjustment. Herein, data adjustment implies data conversion and data generation. Moreover, the information processing apparatus 10 performs data division. For example, the information processing apparatus 10 divides the training data into data for training to be used for training of the model and data for evaluation to be used in evaluation (i.e., used in accuracy measurement) of the model. Meanwhile, the information processing apparatus 10 can further divide data meant for a variety of testing. The operation of dividing the training data into data for training and data for evaluation can be performed using various known technologies.

Moreover, the information processing apparatus 10 generates various generation indexes using the training data. For example, the information processing apparatus 10 generates a config file in which a model generated in AutoML and the training for the model are defined. In such a config file, various functions used in AutoML are stored without modification as information indicating the generation indexes. Then, the information processing apparatus 10 provides the data for training and the generation indexes to the model generation server 2, so that a model is generated.

Herein, the information processing apparatus 10 can repeatedly implement user evaluation of the model and automatic model generation, so as to optimize the generation index and in turn optimize the model. For example, the information processing apparatus 10 optimizes the features that are input (i.e., optimizes the input features and the input cross features), optimizes the hyperparameters, and optimizes the model to be generated; and performs automatic model generation according to the optimized generation index. Then, the information processing apparatus 10 provides the generated model to the user.

On the other hand, the user performs training, evaluation, and testing of the automatically-generated model, and performs analysis or provision of the model. Then, the user corrects the generation index that is generated, ensures that a new model is again automatically generated, and performs evaluation and testing. As a result of repeatedly performing such operations, the operation for enhancing the degree of accuracy of the model can be implemented by a trial-and-error method without having to perform any complex operations.

### 4. Configuration of Information Processing Apparatus

Explained below with reference to FIG. 3 is an exemplary functional configuration of the information processing apparatus 10 according to the embodiment. FIG. 3 is a diagram illustrating an exemplary configuration of the information processing apparatus according to the embodiment. As illustrated in FIG. 3, the information processing apparatus 10 includes a communication unit 20, a memory unit 30, and a control unit 40.

The communication unit 20 is implemented using, for example, an NIC (Network Interface Card). The communication unit 20 is connected to the network N in a wired manner or in a wireless manner, and communicates information with the model generation server 2 and the terminal device 3.

The memory unit 30 is implemented using, for example, a semiconductor memory device such as a RAM (Random Access Memory) or a flash memory; or using a memory device such as a hard disk or an optical disk. The memory unit 30 includes a training data database 31 and a model generation database 32.

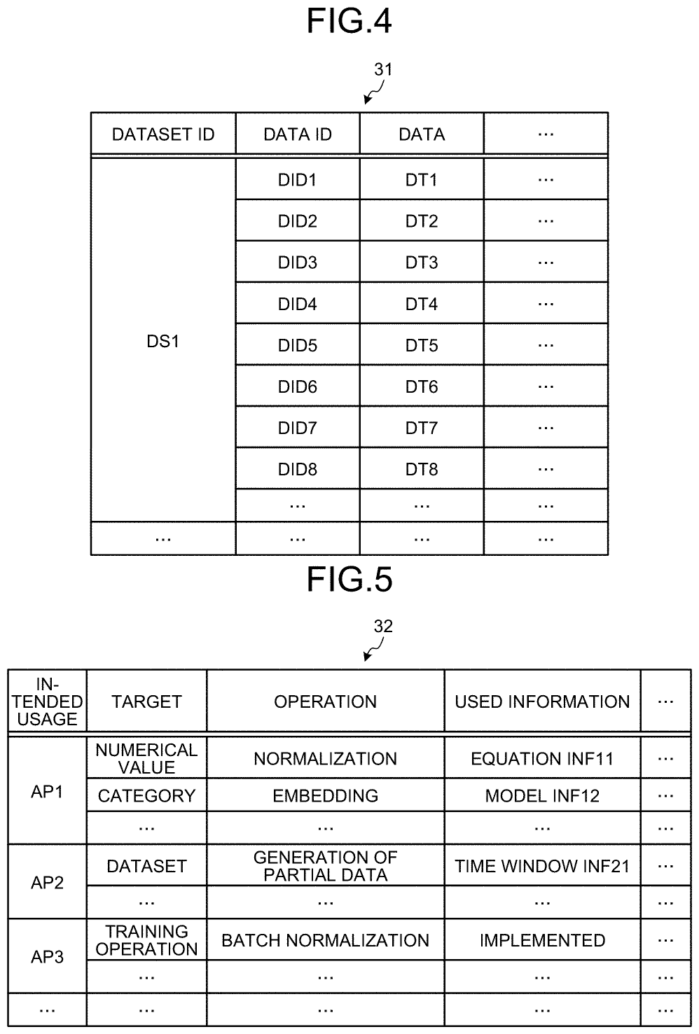

The training data database 31 is used to store a variety of information related to the data used for training. In the training data database 31, the datasets of training data used in the training of models are stored. FIG. 4 is a diagram illustrating an example of the information registered in the training data database according to the embodiment. In the example illustrated in FIG. 4, the training data database 31 includes items such as “dataset ID”, “data ID”, and “data”.

The item “dataset ID” represents identification information enabling identification of a dataset. The item “data ID” represents identification information enabling identification of data. The item “data” represents the data identified by a data ID. For example, in the example illustrated in FIG. 4, data IDs enabling identification of sets of training data are stored in a corresponding manner to the corresponding data (training data).

In the example illustrated in FIG. 4, the dataset identified by a dataset ID “DS1” (i.e., a dataset DS1) includes a plurality of sets of data “DT1”, “DT2”, and “DT3” identified by data IDs “DID1”, “DID2”, and “DID3”, respectively. Meanwhile, in FIG. 4, the sets of data are indicated using abstract character strings such as “DT1”, “DT2”, and “DT3”. However, for example, information in an arbitrary format such as various integers, floating decimal points, or character strings can be registered as the data.

Meanwhile, although not illustrated in FIG. 4, in the training data database 31, labels (correct-solution information) corresponding to the sets of data can be stored in a corresponding manner to the sets of data. Alternatively, for example, a single label can be stored in a corresponding manner to a data group including a plurality of sets of data. In that case, a data group including a plurality of sets of data corresponds to the data to be input to a model (input data). As a label, information in an arbitrary format such as a numerical value or a character string is used.

Meanwhile, the training data database 31 is not limited to store the information mentioned above, and can be used to store a variety of other information according to the objective. For example, the training data database 31 can store the sets of data in a manner enabling identification about whether a set of data is to be used in a training operation (data for training) or is to be used in evaluation (data for evaluation). For example, the training data database 31 can used to store, in a corresponding manner, information (a flag) enabling identification of whether a set of data represents data for training or data for evaluation.

The model generation database 32 is used to store a variety of information, other than the training data, that is used in model generation. The model generation database 32 is used to store a variety of information related to three types of operations (the first operation, the second operation, and the third operation) meant for reducing the variability in the weight representing a parameter of a model. The model generation database 32 illustrated in FIG. 5 includes items such as “intended usage”, “target”, “operation”, and “used information”.

The item “intended usage” represents the intended usage of the corresponding information. In FIG. 5, the intended usages are indicated using abstract character strings such as “AP1”, “AP2”, and “AP3”. However, in the item “intended usage”, identification information (intended usage ID) enabling identification of the intended usage is registered, or a character string that specifies the intended usage is registered. For example, the intended usage “AP1” represents data conversion corresponding to the first operation. The intended usage “AP2” represents data generation corresponding to the second operation. The intended usage “AP3” represents the training form corresponding to the third operation. In this way, the item “intended usage” indicates the operation in which the corresponding information is to be used.

The item “target” represents the target for application of the operation. The item “operation” represents the operation details to be applied to the corresponding target. The item “used information” represents the information to be used in the corresponding operation and indicates whether or not the corresponding operation is to be applied.

For example, in FIG. 5, in the data conversion represented by the intended usage “AP1”, when the target is “numerical value”, it is indicated that a normalization operation is performed using an equation INF11. In FIG. 5, although an abstract character string such as the equation INF11 is illustrated, the equation INF11 represents a specific equation (function) such as Equation (1) or Equation (2) that is mentioned later and that is meant for implementing normalization. That is, it is indicated that, when the training data points to an item related to a numerical value, the normalization is performed by applying the equation INF11.

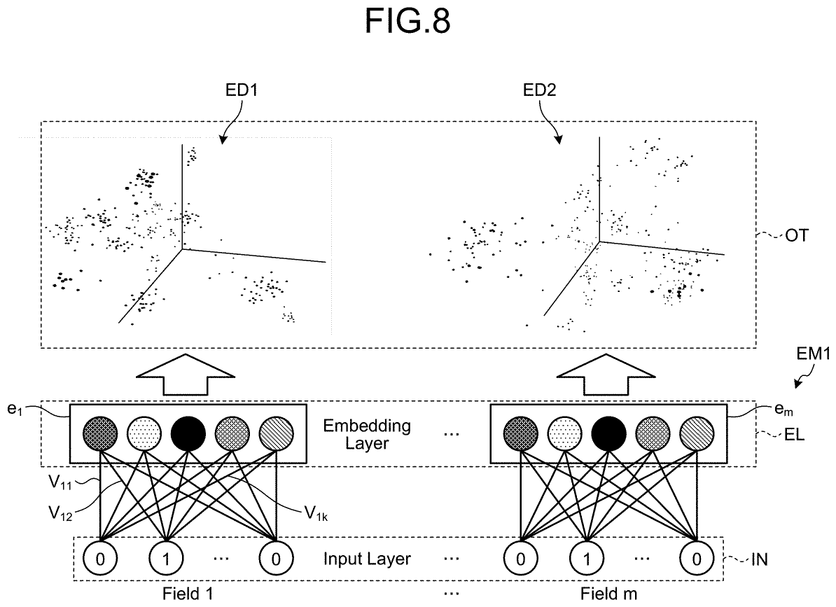

Moreover, in FIG. 5, in the data conversion represented by the intended usage “AP1”, when the target is “category”, it is indicated that embedding (vectorization) is performed using a model INF12. In FIG. 5, although an abstract character string such as the model INF12 is illustrated, the model INF12 includes a variety of information constituting the model, such as information and functions related to the network corresponding to a vector conversion model EM1 illustrated in FIG. 8. That is, when the training data points to an item related to a category, it is indicated that embedding (vectorization) is performed using the model INF12.

Meanwhile, in FIG. 5, in the data represented by the intended usage “AP2”, it is indicated that an operation of generating partial data from the target “dataset” is performed using a time window INF21. In FIG. 5, although an abstract character string such as the time window INF21 is illustrated, the time window INF21 represents information indicating a predetermined time range such as one week, one day, or three hours.

In FIG. 5, in the training form represented by the intended usage “AP3”, it is indicated that batch normalization is applied (used) in the target “training operation”. Meanwhile, in FIG. 5, although a character string such as “available” is illustrated, it is also possible to use a numerical value (flag) such as “0” indicating nonapplication (nonuse) or “1” indicating application (use).

Meanwhile, the model generation database 32 is not limited to store the information mentioned above, and can be used to store a variety of other model information as long as it is used in model generation.

Returning to the explanation with reference to FIG. 3, the control unit 40 is implemented when, for example, a CPU (Central Processing Unit) or an MPU (Micro Processing Unit) executes various programs, which are stored in an internal memory device of the information processing apparatus 10, using a RAM as the work area. Alternatively, the control unit 40 is implemented using, for example, an integrated circuit such as an ASIC (Application Specific Integrated Circuit) or an FPGA (Field Programmable Gate Array). As illustrated in FIG. 3, the control unit 40 includes an obtaining unit 41, a learning unit 42, a deciding unit 43, a receiving unit 44, a generating unit 45, and a providing unit 46.

The obtaining unit 41 obtains information from the memory unit 30. The obtaining unit 41 obtains a dataset of the training data used in the training of a model. The obtaining unit 41 obtains the training data to be used in the training of a model. For example, when a variety of data to be used as training data and labels assigned to the variety of data are received from the terminal device 3, the obtaining unit 41 registers the received data and the labels as the training data in the training data database 31. Meanwhile, from among the data registered in advance in the training data database 31, the obtaining unit 41 can receive specification of the training data ID and the label of the training data to be used in the training of a model.

The learning unit 42 learns a vector conversion model that converts the training data, which points to an item related to a category, into vectors. The learning unit 42 generates a vector conversion model by performing a training operation. The learning unit 42 generates a vector conversion model trained in the features of the training data. The learning unit 42 generates a vector conversion model in such a way that there is a decrease in the variability in the distribution of the vectors output by the vector conversion model.

The deciding unit 43 decides on the training form. The deciding unit 43 decides on the training form based on the information about the application or nonapplication of batch normalization as stored in the model generation database 32.

The receiving unit 44 receives correction of the generation index that is presented to the user. Moreover, the receiving unit 44 receives, from the user, specification about the features of the training data in which the model is to be trained, the form of the model to be generated, and the sequence of deciding on the training form at the time of training a model in the features of the training data.

The generating unit 45 generates a variety of information according to the decision made by the deciding unit 43. Moreover, the generating unit 45 generates a variety of information according to an instruction received by the receiving unit 44. For example, the generating unit 45 can generate a generation index for the model.

The generating unit 45 uses a dataset and generates a model in such a way that there is a decrease in the variability in the weight. Thus, the generating unit 45 generates a model in such a way that there is a decrease in the standard deviation or the dispersion of the weight.

The generating unit 45 generates a model using post-conversion training data that is obtained by conversion of the training data in such a way that there is a decrease in the variability in the weight of the model. The generating unit 45 generates a model using the post-conversion training data obtained as a result of normalizing the training data. The generating unit 45 generates a model using the post-conversion training data obtained by converting the training data into vectors. The generating unit 45 converts the training data into post-conversion training data.

When the training data points to an item related to a numerical value, the generating unit 45 normalizes the training data and generates post-conversion training data. The generating unit 45 uses a predetermined conversion function meant for normalizing the training data, and generates post-conversion training data as a result of normalization of the training data. When the training data points to an item related to a category, the generating unit converts the training data into vectors and generates post-conversion training data. The generating unit 45 uses a vector conversion model meant for embedding the training data, and generates post-conversion training data obtained by conversion of the training data into vectors.

The generating unit 45 generates a model using a partial data group generated from a dataset based on a predetermined range. The generating unit 45 generates a model using a partial data group generated from a dataset, in which sets of training data are associated to time, based on a time window indicating a predetermined time range. The generating unit 45 generates a model using a partial data group in which a plurality of sets of partial data overlappingly contains a single set of training data. The generating unit 45 generates a model, with the data corresponding to each partial data group serving as the data to be input to the model.

The generating unit 45 generates a model using batch normalization. The generating unit 45 generates a model using batch normalization in which the input of each layer of the model is normalized. The generating unit 45 generates a model by sending the data used in model generation to the external model generation server 2; requesting the model generation server 2 to learn the model; and receiving the model learnt by the model generation server 2 from the model generation server 2.

For example, the generating unit 45 generates a model using the data registered in the training data database 31. The generating unit 45 generates a model based on the sets of data and the labels used as the data for training. The generating unit 45 generates a model by performing training in such a way that the output result output by the model in response to the input of the data for training matches with the labels. For example, the generating unit 45 generates a model by sending, to the model generation server 2, the sets of data and the labels used as the data for training; and training the model generation server 2 in the model.

For example, the generating unit 45 measures the degree of accuracy of the model using the data registered in the training data database 31. The generating unit 45 measures the degree of accuracy based on the sets of data and the labels used as the data for evaluation. The generating unit 45 measures the degree of accuracy of the model by collecting the result of comparison of the output result, which is output by the model in response to the input of the data for evaluation, with the labels.

The providing unit 46 provides the generated model to the user. For example, when the model generated by the generating unit 45 has the degree of accuracy exceeding a predetermined threshold value, the providing unit 46 sends that model and the corresponding generation index to the terminal device 3. As a result, the user becomes able to evaluate the model and take a trial thereof, and to correct the generation index.

The providing unit 46 provides the index, which is generated by the generating unit 45, to the user. For example, the providing unit 46 sends a config file of AutoML, which is generated to represent the generation index, to the terminal device 3. Moreover, every time the generation index is generated, the providing unit 46 can present it to the user. For example, the providing unit 46 can present the generation index to the user only if it corresponds to the model having the degree of accuracy exceeding a predetermined threshold value.

### 5. Operation Flow in Information Processing Apparatus

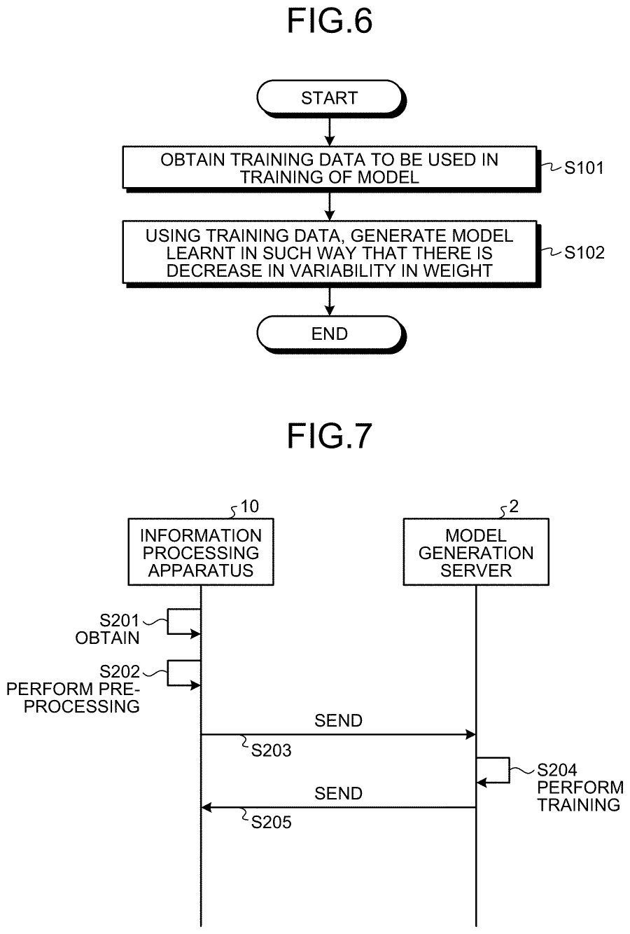

Explained below with reference to FIG. 6 is the sequence of operations performed in the information processing apparatus 10. FIG. 6 is a flowchart for explaining an exemplary flow of information processing performed according to the embodiment.

For example, the information processing apparatus 10 obtains the training data that is to be used in the training of a model (Step S101). Then, the information processing apparatus 10 uses the training data and generates a model learnt in such a way that there is a decrease in the variability in the weight (Step S102).

### 6. Operation Flow of Information Processing System

Explained below with reference to FIG. 7 is an example of the specific operations performed in the information processing system. FIG. 7 is a sequence diagram illustrating the sequence of operations performed in the information processing system according to the embodiment.

As illustrated in FIG. 7, the information processing apparatus 10 obtains the training data (Step S201). Then, the information processing apparatus 10 performs preprocessing (Step S202). For example, the information processing apparatus 10 converts the training data into post-conversion training data that is to be input to the model. Moreover, for example, in the training operation, the information processing apparatus 10 determines whether or not to apply batch normalization.

The information processing apparatus 10 sends the information to be used in model generation to the model generation server 2 for getting trained in the model (Step S203). For example, the information processing apparatus 10 sends, as the information to be used in model generation to the model generation server 2, the generated post-conversion training data and the information indicating whether or not to apply batch normalization.

Upon receiving the information from the information processing apparatus 10, the model generation server 2 generates a model according to the training operation (Step S204). Then, the model generation server 2 sends the generated model to the information processing apparatus 10. In this way, “generating a model” according to the application concerned is a concept that is not limited to training the concerned device in a model, but that also includes providing the information required in model generation to another device, instructing the other device to generate a model, and receiving the model learnt by the other device. In the information processing system 1, in order to generate a model, the information processing apparatus 10 sends the information to be used in model generation to the model generation server 2 that learns models, and obtains a model generated by the model generation server 2. In this way, in order to generate a model, the information processing apparatus 10 sends the information to be used in model generation to another device and requests the other device to generate a model, so that the other device generates a model in response to the request.

### 7. Regarding Three Operations

Given below is the explanation of the three operations, namely, the first operation, the second operation, and the third operation meant for reducing the variability in the weight of a model. Meanwhile, the information related to the three operations, namely, the first operation, the second operation, and the third operation can be used as the generation indexes explained earlier. That is, the first operation, the second operation, and the third operation can be treated as the operations in which the generation indexes are used.

For example, the information processing apparatus 10 can use, as a generation index, the information related to the data converted in the first operation. For example, the information indicating the type of the data converted in the first operation can be treated as the generation index (also called a “first-type generation index”), and can be sent to the model generation server 2 along with the data converted in the first operation. In that case, the model generation server 2 generates a model using the data converted in the first operation and using the first-type generation index.

For example, the information processing apparatus 10 can use, as a generation index, the information indicating the time window decided in the second operation. For example, the information processing apparatus 10 can send, to the model generation server 2, the size of the time window, which is decided in the second operation, as the generation index (also called a “second-type generation index”). In that case, the model generation server 2 generates a model using the partial data group obtained by partitioning the data according to the size of the time window indicated by the second-type generation index.

For example, the information processing apparatus 10 can use, as the generation index, the information indicating whether or not to perform the third operation. For example, the information processing apparatus 10 can send, as the generation index (also called a “third-type generation index”), the information of a flag indicating whether or not to perform the third operation to the model generation server 2. In that case, if the third-type generation index is a flag (value) indicating execution of batch normalization, then the model generation server 2 generates a model by performing batch normalization. On the other hand, if the third-type generation index is a flag (value) indicating nonexecution of batch normalization, then the model generation server 2 generates a model without performing batch normalization.

In this way, the three operations, namely, the first operation, the second operation, and the third operation either can be incorporated as part of the model generation using the generation indexes, or can be performed separately from the model generation using the generation indexes.

[7-1. First Operation]

Firstly, the explanation is given about the first operation. The information processing apparatus 10 performs the first operation in which the training data is converted in such a way that there is a decrease in the variability in the weight of the model. For example, the information processing apparatus 10 performs the first operation for converting the training data and generating post-conversion training data.

The information processing apparatus 10 performs the first operation in which the conversion is performed in a different manner according to the type of data. For example, according to whether the item corresponding to the training data represents a numerical value or a category, the information processing apparatus 10 performs a different type of conversion in the first-type operation.

[7-1-1. In Case of Numerical Value]

When the training data points to an item related to a numerical value, the information processing apparatus 10 performs the first operation in which the training data is normalized. For example, when the training data points to an item related to a numerical value, the information processing apparatus 10 performs the first operation in which the training data is normalized using a conversion function as given below in Equation (1).

$${x}^{′} = \frac{x - min ( x )}{max ( x ) - min ( x )} \qquad ( 1 )$$

In Equation (1), “x′” on the left side represents the post-conversion training data (post-conversion numerical value). Moreover, in Equation (1), “x” on the right side represents the pre-conversion training data (pre-conversion numerical value). Furthermore, in Equation (1), “max(x)” on the right side represents the highest value among the training data pointing to the concerned item. Moreover, in Equation (1), “min(x)” on the right side represents the lowest value among the training data pointing to the concerned item.

The information processing apparatus 10 uses the conversion function given in Equation (1) and normalizes the training data, which points to an item related to a numerical value, to a value equal to or greater than “0” and equal to or smaller than “1”. As a result, the information processing apparatus 10 becomes able to hold down the variability in the training data equivalent to the item related to a numerical value. With that, the information processing apparatus 10 can reduce the variability in the weight of the model, and enhance the degree of accuracy of the model.

Meanwhile, when the training data points to an item related to a numerical value, instead of using Equation (1) given above, the information processing apparatus 10 can use a conversion function given below in Equation (2) and perform the first operation for normalizing the training data.

$${x}^{′} = \frac{x - average ( x )}{max ( x ) - min ( x )} \qquad ( 2 )$$

Regarding identical points to Equation (1), the explanation is not given again. In Equation (2), “average (x)” on the right side represents the average value of the training data pointing to the concerned item. Meanwhile, the explanation given above is only exemplary. Thus, instead of using Equations (1) and (2), the information processing apparatus 10 can use a variety of other information and convert the training data pointing to an item related to a numerical value.

[7-1-2. In Case of Category]

When the training data points to an item related to a category, the information processing apparatus 10 performs the first operation in which the training data is normalized. For example, when the training data points to an item related to a category, the information processing apparatus 10 the first operation in which a vector conversion model is used for embedding (vectorization) of the training data. In that case, the information processing apparatus 10 uses the vector conversion model EM1 illustrated in FIG. 8 and generates post-conversion training data by converting the training data into vectors. FIG. 8 is a diagram illustrating the concept of the first operation according to the embodiment. The vector conversion model EM1 includes an input layer IN, an embedding layer EL that corresponds to an intermediate layer, and an output layer.

For example, in the vector conversion model EM1, when the training data pointing to an item related to a category is input to the input layer IN, the features are extracted in the embedding layer EL, and the vectorized training data (the post-conversion training data) is output from the output layer. In output data OT illustrated in FIG. 8, embedding data ED1 and ED2 represents the training data that has been subjected to the first operation in the vector conversion model EM1, that is, represents the post-conversion training data. The embedding data ED1 and ED2 are images formed as a result of mapping of N-dimensional vector data (the post-conversion training data) into the three-dimensional space.

The information processing apparatus 10 can learn the vector conversion model EM1. In that case, the information processing apparatus 10 performs the training operation for learning the features of the data (training data) used in the training of the vector conversion model EM1. For example, the information processing apparatus 10 learns the vector conversion model EM1 in such a way that there is a decrease in the variability in the distribution of the vectors output by the vector conversion model EM1. For example, the information processing apparatus 10 learns the vector conversion model EM1 in such a way that there is a decrease in the variability in the vector data indicated by the embedding data ED1. Moreover, for example, the information processing apparatus 10 learns the vector conversion model EM1 in such a way that there is a decrease in the variability in the vector data indicated by the embedding data ED2. The information processing apparatus 10 appropriately implements various conventional technologies related to machine learning, and learns the vector conversion model EM1 in such a way that there is a decrease in the variability in the distribution of the vectors output by the vector conversion model EM1.

As a result, the information processing apparatus 10 becomes able to hold down the variability in the training data pointing to an item related to a category. Hence, the information processing apparatus 10 can reduce the variability in the weight of the model, and can enhance the degree of accuracy of the model. Meanwhile, the explanation given above is only exemplary, and the information processing apparatus 10 can appropriately use a variety of information and convert the training data pointing to an item related to a category.

[7-2. Second Operation]

Given below is the explanation of the second operation. The information processing apparatus 10 performs the second operation for generating a partial data group from a dataset based on a predetermined range in such a way that there is decrease in the variability in the weight of the model. For example, the information processing apparatus 10 performs the second operation for generating a partial data group based on the time window indicating a predetermined time range.

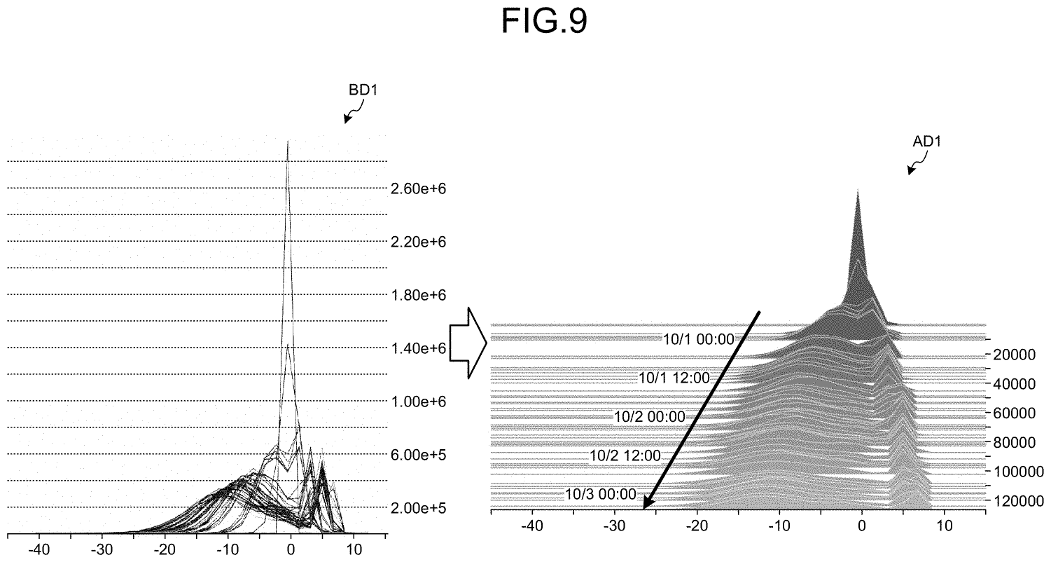

In this way, the information processing apparatus 10 ensures that the training of a model is performed using the data partitioned on the basis of time. That point is explained below with reference to FIG. 9. FIG. 9 is a diagram illustrating the concept of the second operation according to the embodiment. In FIG. 9, the graph on the left side represents data BD1 that serves as the basis for generating data partitioned on the basis of time. For example, in the data BD1, the horizontal axis represents time; and the vertical axis represents, for example, the frequency of occurrence of a predetermined event such as the number of times of a predetermined action taken by the user. In the data BD1, a plurality of lines corresponding to a plurality of sets of data is illustrated together, and each line corresponds to a set of data to be input to the model. In this way, the data BD1 represents data having large variability in the vertical axis direction. In such a case, the variability increases also in the data to be input to the model.

In that regard, the information processing apparatus 10 partitions the data AD1 on the basis of time and generates data corresponding to the data to be input to the model. For example, in the information processing apparatus 10, the data AD1 is generated by partitioning the sets of data of the data AD1 on the basis of a time window (for example, 12 hours or one day). In FIG. 9, the graph on the right side represents the data AD1 generated as a result partitioning performed on the basis of a time window.

For example, in the data AD1, the horizontal axis represents time; and the vertical axis represents, for example, the frequency of occurrence of a predetermined event such as the number of times of a predetermined action taken by the user. In the data AD1, the sets of data generated as a result of partitioning performed on the basis of a time window are illustrated in a superimposed manner, and the waveforms thereof correspond to the sets of data to be input to the model. In this way, the data AD1 represents the data in which the variability in the vertical axis direction is held down. In such a case, the variability is held down also for the data to be input to the model. Meanwhile, there can be temporal overlapping in the sets of data in the data AD1, or overlapped data can be included in the sets of data in the data AD1.

The information processing apparatus 10 can partition the data according to a time window indicating an arbitrary time range. The information processing apparatus 10 can optimize the size of the time window, that is, optimize the time width (time range). For example, the information processing apparatus 10 can set the time window in such a way that, in a set of data generated as a result of performing partitioning according to the time window, the number of records is within a predetermined range. For example, the information processing apparatus 10 can set the time window in such a way that, in the partial data group (also called “partitioned data”) generated as a result of performing partitioning according to the time window, the number of records is within the range of one hundred thousand records to two hundred thousand records.

As explained above, the information processing apparatus 10 decides on the size of the time window. The information processing apparatus 10 decides on the size of the time window in such a way that the number of records included in a partitioned set of data is within a predetermined range. For example, the information processing apparatus 10 can decide on the size of the time window using the information (record count information) that indicates the range of the number of records of the partitioned data having a high degree of accuracy in the past model generation (i.e., indicates the range of the optimum record count). The information processing apparatus 10 can decide on the size of the time window in such a way that the number of records of data included each set of partitioned data is within the range of the optimum record count indicated by the record count information.

For example, the information processing apparatus 10 can decide on the size of the time window according to the details of the data. For example, the information processing apparatus 10 can decide on the size of the time window according to the type of the data. For example, the information processing apparatus 10 can decide on the size of the time window using the information (size information) in which the size of the time window is associated to each type of data. For example, the information processing apparatus 10 can decide on the size of the time window using the information (size information) in which the size of the time window having a high degree of accuracy in the past model generation is associated to each type of data. For example, in the size information, if the size “12 hours” of the time window is associated to a type “user action log” of the data, the information processing apparatus 10 can decide on generating partitioned data by partitioning (dividing) the data of the type “user action log” according to the size of 12 hours.

Moreover, at the time of optimizing the size of the time window, the information processing apparatus can also simultaneously optimize the batch size and the learning rate. As a result, the information processing apparatus 10 can further enhance the degree of accuracy of the model.

[7-3. Third Operation]

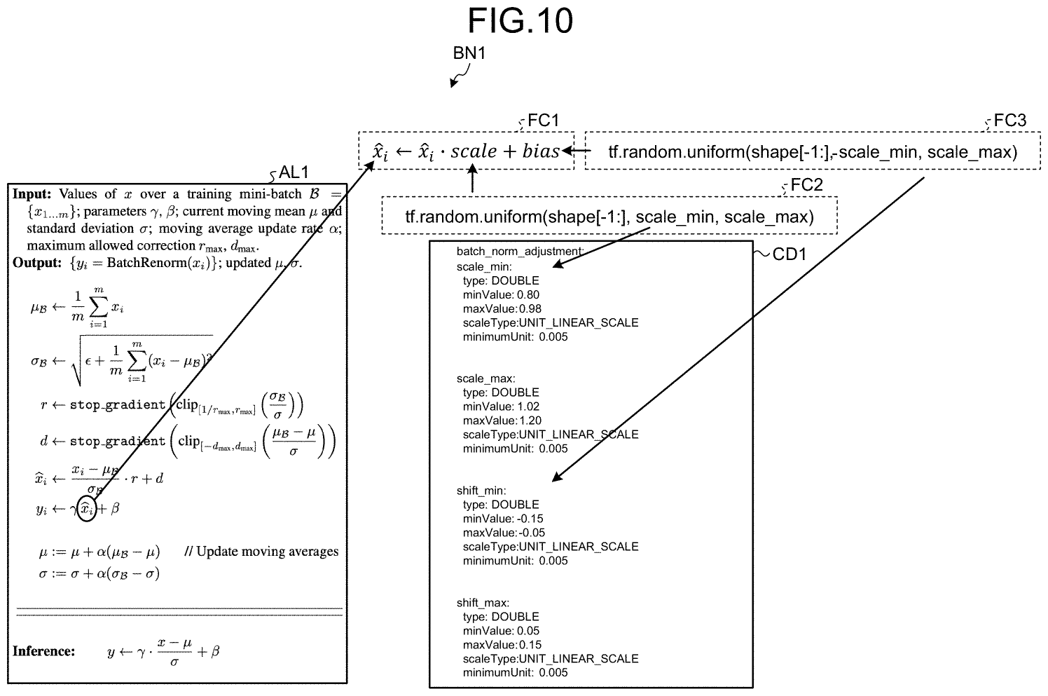

Given below is the explanation of the third operation. The information processing apparatus 10 performs the third operation representing batch normalization in such a way that there is a decrease in the variability in the weight of the model. For example, the information processing apparatus 10 performs the third operation for normalizing the input of each layer of the model. That point is explained below with reference to FIG. 10. FIG. 10 is a diagram illustrating the concept of the third operation according to the embodiment. In FIG. 10, an overall picture BN1 represents the overview of the batch normalization performed as the third operation. Moreover, in FIG. 10, an algorithm AL1 represents an algorithm related to batch normalization. Furthermore, in FIG. 10, a function FC1 represents a function for applying batch normalization. The function FC1 illustrated in FIG. 10 is identical to Equation (3) given below.

\hat{x}ᵢ←\hat{x}ᵢ·scale+bias (3)

Equation (3) represents an example of the function for normalizing the input (i.e., the output of the previous layer) using a parameter “scale” and a parameter “bias”. In Equation (3), the left side of the arrow (←) represents the post-normalization value, and right side of the arrow (←) is calculated by multiplying the parameter “scale” to the pre-normalization value and then adding the parameter “bias” to the multiplication result. In this way, in the example illustrated in FIG. 10, the normalization is performed using the parameters “scale” and “bias”. More particularly, according to the function FC1, normalization is achieved when the value of the parameter “scale” is multiplied to the pre-normalization value and then the value of the parameter “bias” is added to the multiplication result.

In the example illustrated in FIG. 10, the upper limit value and the lower limit value of the parameters “scale” and “bias” are defined using a code CD1. The values of the parameter “scale” are decided according to the code CD1 and a function FC2. For example, the function FC2 is a function for generating a random number in the range having “scale min” as the lower limit and “scale max” as the upper limit.

The values of the parameter “bias” are decided according to a code CD1 and a function FC3. For example, the function FC3 is a function for generating a random number in the range having “shift min” as the lower limit and “shift max” as the upper limit.

In the example illustrated in FIG. 10, the third operation is performed using the function FC1. As a result, the information processing apparatus 10 can hold down the variability in the input of each layer of the model. Hence, the information processing apparatus 10 can reduce the variability in the weight of the model, and enhance the degree of accuracy of the model.

For example, when an API (Application Programming Interface) is provided for enabling the model generation server 2 to receive specification of batch normalization, the information processing apparatus 10 can use that API and instruct the model generation server 2 to perform the third operation.

### 8. Regarding Experimental Results

Given below is the explanation of the experimental results obtained as a result of generating a model by performing the operations explained above.

[8-1. First Experimental Result]

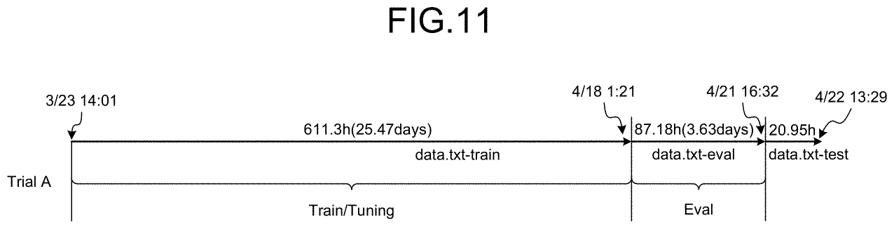

Firstly, explained below with reference to FIGS. 11 to 15 is a first experimental result. The first experimental result is the experimental result obtained when a model recommending accommodating facilities in response to a user action (hereinafter, called “first model”) was generated and the degree of accuracy of that model (the first model) was measured. In the first model, when action data of the user is input, for example, the scores of a large number of intended accommodation facilities, such as tens of thousands of intended accommodation facilities (also called “target accommodation facilities”) are output.

Firstly, explained below with reference to FIG. 11 is the data used in the experiment. FIG. 11 is a diagram illustrating the data used in the experiment. In FIG. 11 is illustrated the relationship between the dataset used in the experiment and time. The dataset used in the experiment is a dataset named “Trial A” illustrated in FIG. 11 and includes user action data (action history).

As illustrated in FIG. 11, the dataset has the time range from “March 23 14:01” to “April 4 13:29”, and the data is chronologically arranged from the oldest data (action data at March 23 14:01) to the latest data for testing (action data at April 22 13:29).

In the example illustrated in FIG. 11, of the dataset, the data between “March 23 14:01” to “April 18 1:21” is assigned as data for tuning (data for training). Thus, it is indicated that a model for recommending accommodation facilities (the first model) was generated in which the data between “March 23 14:01” to “April 18 1:21” is treated as the data for training.

Moreover, in the example illustrated in FIG. 11, of the dataset, the data between “April 18 1:21” to “April 21 16:32” is assigned as data to be used in evaluation (data for evaluation). Thus, it is indicated that the evaluation of the model for recommending accommodation facilities (the first model) was measured by treating the data between “April 18 1:21” to “April 21 16:32” as the data for evaluation.

Furthermore, in the example illustrated in FIG. 11, of the dataset, the data between “April 21 16:32” to “April 23 13:29” is assigned as data to be used in testing (data for testing). Thus, it is indicated that the model for recommending accommodation facilities (the first model) was tested using the data between “April 21 16:32” to “April 23 13:29” as the data for testing.

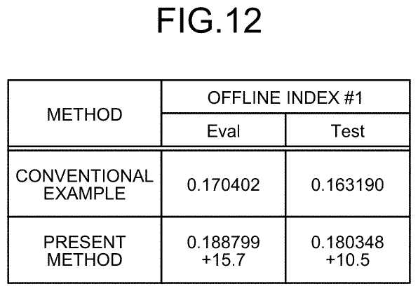

In FIG. 12 is illustrated the first experimental result obtained as a result of using the dataset illustrated in FIG. 11. FIG. 12 is a diagram illustrating a list indicating the first experimental result. In FIG. 12, “offline index #1” represents the reference index for model accuracy. Moreover, in FIG. 12, “Eval” represents the degree of accuracy achieved as a result of using the data for evaluation. Furthermore, in FIG. 12, “Test” represents the degree of accuracy achieved as a result of using the data for testing.

In the list illustrated in FIG. 12, “conventional example” indicates the degree of accuracy of the model achieved when none of the first operation, the second operation, and the third operation was implemented. Moreover, in the list illustrated in FIG. 12, “present method” indicates the degree of accuracy of the model achieved when the first operation and the second operation were implemented.

When the action data of the user was input to a model using the offline index #1 and when the top five accommodation facilities in descending order of scores output by the model were extracted from among the target accommodation facilities, the experiment result illustrated in FIG. 12 indicates the percentage of the accommodation facilities that were actually browsed by the user (for example, the accommodation facilities whose contents were actually read from the corresponding pages).

As illustrated in FIG. 12, regarding the conventional example, the degree of accuracy of “0.170402” was achieved as a result of using the data for evaluation. That is, in the experiment for the conventional example using the data for evaluation, it is indicated that, when the action data of the user was input to the first model and when the top five accommodation facilities in descending order of scores output by the first model were extracted from the target accommodation facilities, 17% of the accommodation facilities were actually browsed by the user.

On the other hand, in the present method, the degree of accuracy of “0.188799” was achieved as a result of using the data for evaluation. That is, in the experiment for the present method using the data for evaluation, it is indicated that, when the action data of the user was input to the first model and when the top five accommodation facilities in descending order of scores output by the first model were extracted from the target accommodation facilities, 18.8% of the accommodation facilities were actually browsed by the user.

When the degrees of accuracy achieved as a result of using the data for evaluation were compared, the present method was seen to have an enhancement (improvement) of “15.7%” in the degree of accuracy over the conventional example.

Moreover, regarding the conventional example, the degree of accuracy of “0.163190” was achieved as a result of using the data for testing. On the other hand, regarding the present method, the degree of accuracy of “0.180348” was achieved as a result of using the data for testing. When the degrees of accuracy achieved as a result of using the data for testing were compared, the present method was seen to have an enhancement (improvement) of “10.5%” in the degree of accuracy over the conventional example.

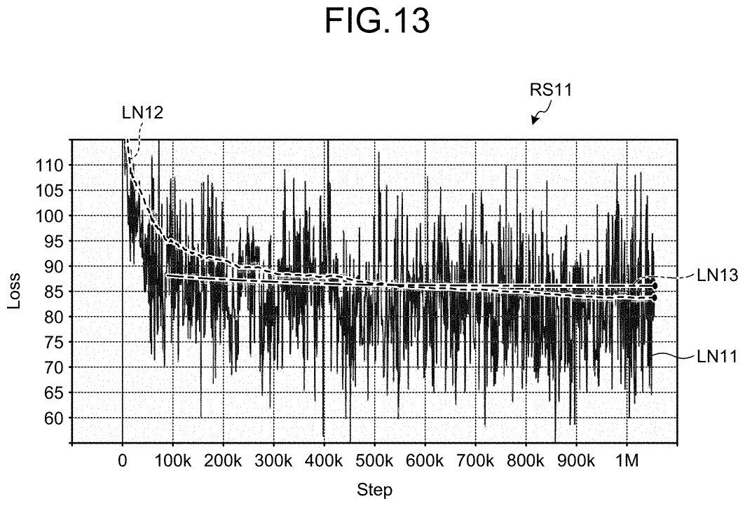

Given below is the explanation about the points related to the experimental result. Firstly, explained below with reference to FIG. 13 is the relationship between the steps and the losses. FIG. 13 is a diagram illustrating a graph related to the first experimental result. In a graph RS11 illustrated in FIG. 13, the horizontal axis represents the steps and the vertical axis represents the losses.

In the graph RS11 illustrated in FIG. 13, lines LN11 to LN13 indicate the relationship between the values and the steps. The line LN11 indicates the relationship between “training loss values” (for example, the loss values during the training) and the steps in the present method. The line LN12 indicates the relationship of “training loss values with EMA (Exponential Moving Average)” (for example, the exponential moving average in the loss values during the training) with the steps in the present method. The line LN13 indicates the relationship between “eval loss values” (for example, the loss values during the evaluation) and the steps in the present method. As illustrated in FIG. 13, in the present method, the loss values converge among substantially fixed values.

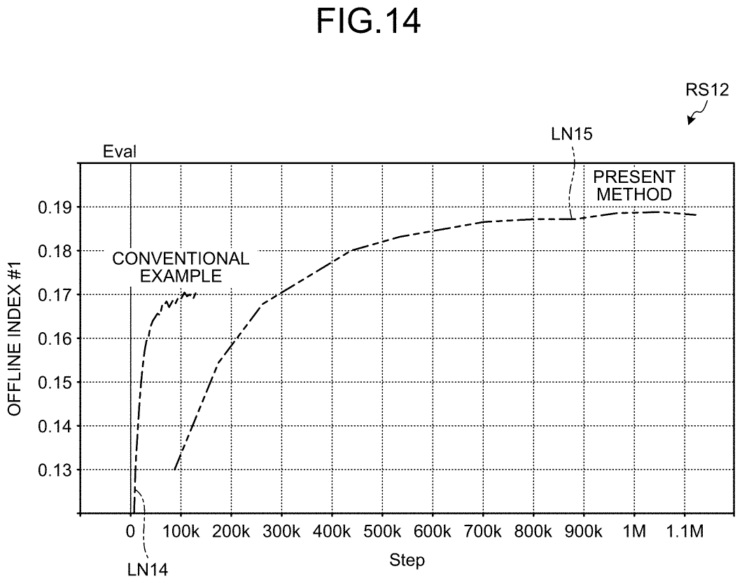

Explained below with reference to FIG. 14 is the relationship between the steps and the degrees of accuracy. FIG. 14 is a diagram illustrating a graph related to the first experimental result. In a graph RS12 illustrated in FIG. 14, the horizontal axis represents the steps and the vertical axis represents the degrees of accuracy.

In the graph RS12 illustrated in FIG. 14, lines LN14 and LN15 indicate the relationship between the degrees of accuracy and the steps in the respective methods. The line LN14 indicates the relationship between the degrees of accuracy and the steps in the conventional example. The line LN15 indicates the relationship between the degrees of accuracy and the steps in the present method. As illustrated in FIG. 14, there is an enhancement in the degrees of accuracy in the present method as compared to the conventional example.

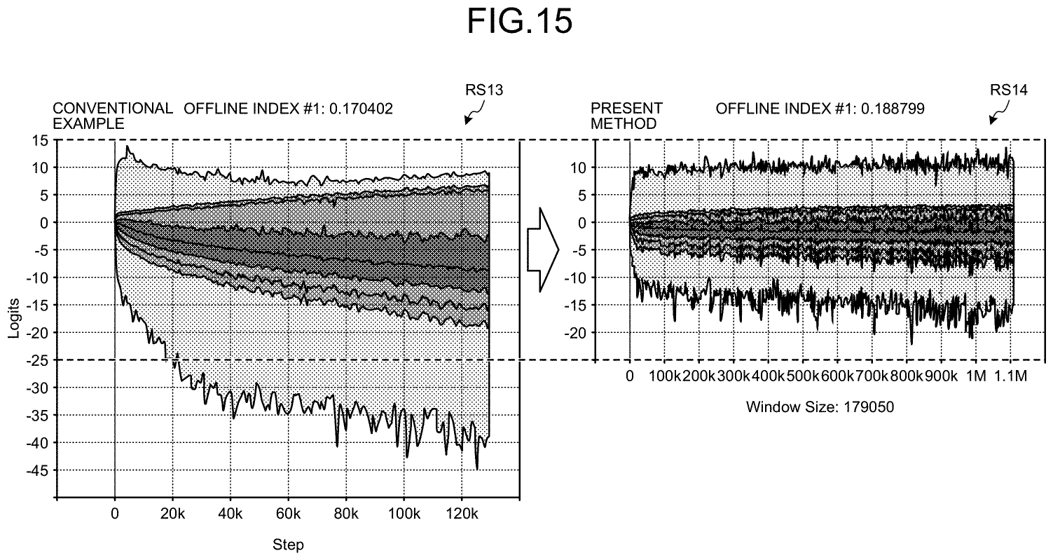

Explained below with reference to FIG. 15 is the relationship between the steps and the weights. FIG. 15 is a diagram illustrating graphs related to the first experimental result. In graphs RS13 and RS14 illustrated in FIG. 15, the horizontal axis represents the steps and the vertical axis represents Logits (the outputs of the model). Moreover, in FIG. 15, “Window Size: 179050” indicates the time window when the first experimental result was obtained. Herein, “179050” indicates the size of the time window. For example, the size of the time window increases in proportion to that value. For example, “window size” indicates the size of the buffer used in feeding data to the input of the model during training (i.e., indicates shuffle buffer size). More particularly, “window size” indicates the buffer used in the shuffling performed at the time of feeding data records (in units of batch size) to the input of the model. For example, in the case of TensorFlow, a module is used as disclosed in https://www.tensorflow.org/api_docs/python/tf/data/Dataset#shuffle that is a literature related to TensorFlow. In the experiment whose result is illustrated in FIG. 15, the shuffle buffer is used (diverted) as the window buffer. Moreover, the size of the window buffer is fixed; and, while moving the data records (to be stored in the buffer) in the time-series direction in the units of batch size, the data records are stored in that buffer (copied in the buffer from data files), are shuffled, and are fed to the input of the model.

The graph RS13 illustrated in FIG. 15 indicates the relationship between the outputs of the model and the steps in the conventional example. In the graph RS13, the waveforms represent the variability in the outputs of the model in the form of standard deviation. In the graph RS13, nine waveforms correspond to maximum (maximum value), μ+1.5σ, μ+σ, μ+0.5σ, μ, μ−0.5σ, μ−σ, μ−1.5σ, and minimum (minimum value) in that order from the top. In the example illustrated in FIG. 15, the center μ has the darkest color, and the color goes on becoming faint toward the outer sides.

The graph RS14 illustrated in FIG. 15 indicates the relationship between the outputs of the model and the steps in the present method. In the graph RS14, the waveforms represent the variability in the outputs of the model in the form of standard deviation. In an identical manner to the graph RS13, in the graph RS14, nine waveforms correspond to maximum (maximum value), μ+1.5σ, μ+σ, μ+0.5σ, μ, μ−0.5σ, μ−σ, μ−1.5σ, and minimum (minimum value) in that order from the top.

As illustrated in FIG. 15, in the present method, there is a decrease in the variability in Logits (the outputs of the model) as compared to the conventional example. As a result of a decrease in Logits (the outputs of the model), the weight value also decreases. Hence, in the present method, there is a decrease in the variability in the weight.

[8-2. Second Experimental Result]

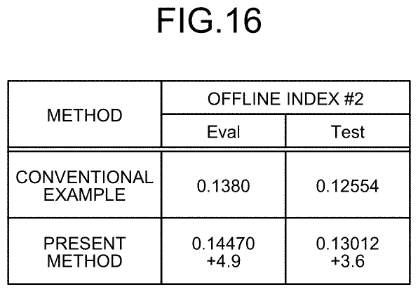

Explained below with reference to FIGS. 16 to 19 is the second experimental result. Regarding the points identical to the first experimental result, the explanation is not given again. The second experimental result is the experimental result obtained when a model that recommends accommodation facilities in response to a user action (hereinafter, called a “second model”) was generated, and the degree of accuracy of that model (the second model) was measured. In the second model, when user action data is input, the scores of a large number of intended accommodation facilities, such as tens of thousands of intended accommodation facilities (target accommodation facilities) are output. The second model is, for example, an identical model to the first model.

Moreover, in the second experimental result, “offline index #2” represents the reference index for model accuracy. In the experimental result illustrated in FIG. 16, when the user action data is input to the model and the scores output by the model are ranked in descending order, the offline index #2 indicates the average of the inverse number of the highest rank from among the accommodation facilities that the user actually browsed. That is, in the list of descending order of scores output by the model, the offline index #2 indicates the average of the inverse number of the rank of the initially-appearing accommodation facility that the user actually browsed. For example, if the initially-appearing accommodation facility that the user browsed has the rank “2”, the offline index #2 becomes equal to “0.5 (=½)”.

FIG. 16 is a diagram illustrating a list indicating the second experimental result. For example, in FIG. 16 is illustrated the second experimental result obtained when the dataset illustrated in FIG. 11 was used.

As illustrated in FIG. 16, regarding the conventional example, the degree of accuracy was equal to “0.1380” as a result of using the data for evaluation. On the other hand, regarding the present method, the degree of accuracy was equal to “0.14470” as a result of using the data for evaluation. When the degrees of accuracy achieved as a result of using the data for evaluation were compared, the present method was seen to have an enhancement (improvement) of “4.9%” in the degree of accuracy over the conventional example.

Moreover, regarding the conventional example, the degree of accuracy was “0.12554” as a result of using the data for testing. On the other hand, regarding the present method, the degree of accuracy was equal to “0.13012” as a result of using the data for testing. When the degrees of accuracy achieved as a result of using the data for testing were compared, the present method was seen to have an enhancement (improvement) of “3.6%” in the degree of accuracy over the conventional example.

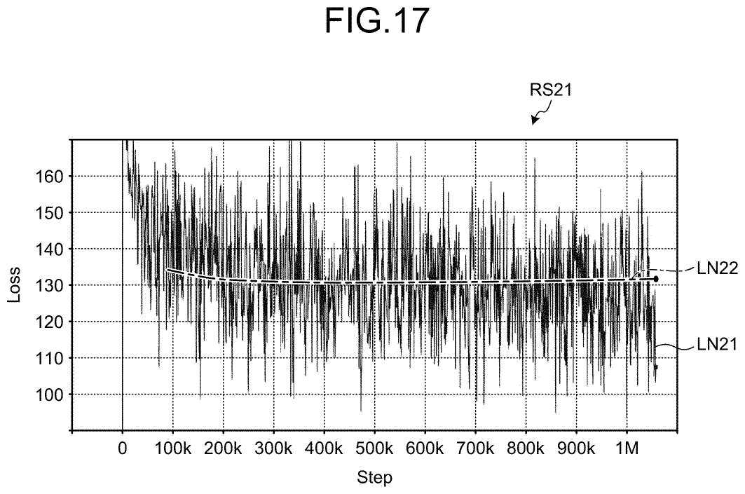

Given below is the explanation about the points related to the experimental result. Firstly, explained below with reference to FIG. 17 is the relationship between the steps and the losses. FIG. 17 is a diagram illustrating a graph related to the second experimental result. In a graph RS21 illustrated in FIG. 17, the horizontal axis represents the steps, and the vertical axis represents the losses.

In the graph RS21 illustrated in FIG. 17, lines LN21 and LN22 indicate the relationship between the values and the steps. The line LN21 indicates the relationship between “training loss values” (for example, the loss values during the training) and the steps in the present method. The line LN22 indicates the relationship between “eval loss values” (for example, the loss values during the evaluation) and the steps in the present method. As illustrated in FIG. 17, in the present method, the loss values converge among substantially fixed values.

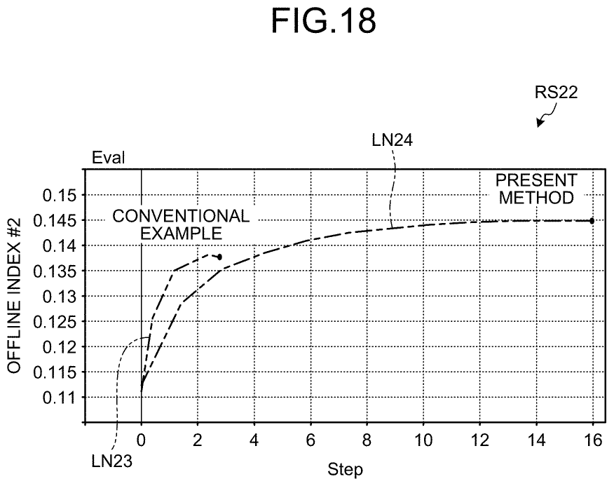

Explained below with reference to FIG. 18 is the relationship between the steps and the degrees of accuracy. FIG. 18 is a diagram illustrating a graph related to the second experimental result. In a graph RS22 illustrated in FIG. 18, the horizontal axis represents the steps and the vertical axis represents the degrees of accuracy.

In the graph RS22 illustrated in FIG. 18, lines LN23 and LN24 indicate the relationship between the degrees of accuracy and the steps in the respective methods. The line LN23 indicates the relationship between the degrees of accuracy and the steps in the conventional example. The line LN24 indicates the relationship between the degrees of accuracy and the steps in the present method. As illustrated in FIG. 18, there is an enhancement in the degrees of accuracy in the present method as compared to the conventional example.

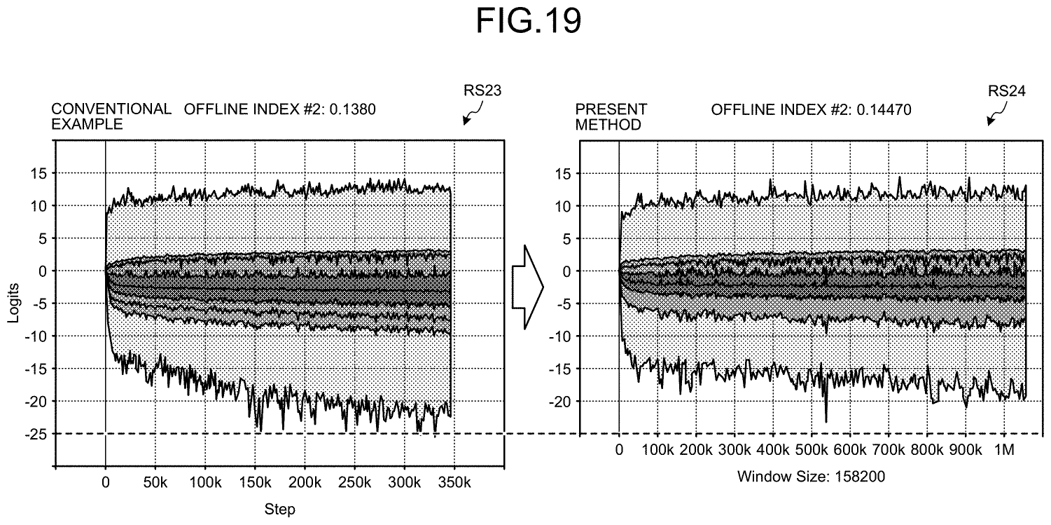

Explained below with reference to FIG. 19 is the relationship between the steps and the weights. FIG. 19 is a diagram illustrating graphs related to the second experimental result. In graphs RS23 and RS24 illustrated in FIG. 19, the horizontal axis represents the steps and the vertical axis represents Logits (the outputs of the model). Moreover, in FIG. 19, “Window Size: 158200” indicates the time window when the second experimental result was obtained.

The graph RS23 illustrated in FIG. 19 indicates the relationship between the outputs of the model and the steps in the conventional example. In the graph RS23, the waveforms represent the variability in the outputs of the model in the form of standard deviation. In the graph RS23, the nine waveforms are identical to the waveforms in the graph RS13 illustrated in FIG. 15. Hence, their detailed explanation is not given again. The graph RS24 illustrated in FIG. 19 indicates the relationship between the outputs of the model and the steps in the present method. In the graph RS24, the waveforms represent the variability in the outputs of the model in the form of standard deviation. In the graph RS24, the nine waveforms are identical to the waveforms in the graph RS14 illustrated in FIG. 15. Hence, their detailed explanation is not given again.

As illustrated in FIG. 19, in the present method, there is a decrease in the variability in Logits (the outputs of the model) as compared to the conventional example. As a result of a decrease in Logits (the outputs of the model), the weight value also decreases. Hence, in the present method, there is a decrease in the variability in the weight.

[8-3. Third Experimental Result]

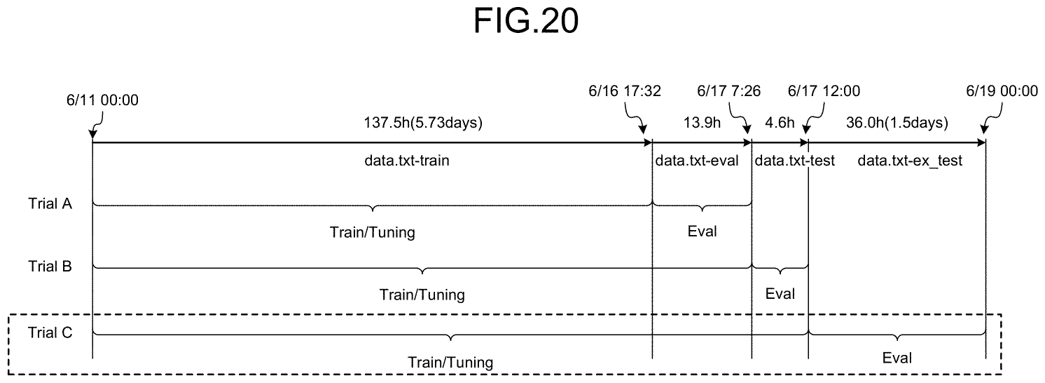

Explained below with reference to FIGS. 20 to 24 is the third experimental result. Regarding the identical points to the first experimental result and the second experimental result, the explanation is not given again. The third experimental result is the experimental result obtained when a model that recommends books in response to a user action (hereinafter, called a “third model”) was generated, and the degree of accuracy of that model (the third model) was measured. In the third model, when user action data is input, the scores of a large number of intended books, such as tens of thousands of intended books (target books) are output.

Explained below with reference to FIG. 20 is the data used in the experiment. FIG. 20 is a diagram illustrating the data used in the experiment. In FIG. 20 is illustrated the relationship between the dataset used in the experiment and time. The dataset used in the experiment is a dataset named “Trial C” in FIG. 20 and includes user action data (action history).

As illustrated in FIG. 20, the dataset includes the time range from “June 11 00:00” to “June 19 00:00”, and the sets of data from the oldest set of data in that time range (i.e., action data at June 6 00:00) to the latest set of data (i.e., action data at June 9 00:00) are arranged in chronological order.

In the example illustrated in FIG. 20, of the dataset, the data from “June 11 00:00” to “June 17 12:00” is assigned as the data for tuning (data for training). That is, it is indicated that, using the data from “June 11 00:00” to “June 17 12:00” as the data for training, the model for recommending books (the third model) was generated.

Moreover, in the example illustrated in FIG. 20, of the dataset, the data from “June 17 12:00” to “June 19 00:00” is assigned as the data to be used in evaluation (the data for evaluation). That is, it is indicated that, using the data from “June 17 12:00” to “June 19 00:00” as the data for evaluation, the evaluation of the model for recommending books (the third model) was measured.

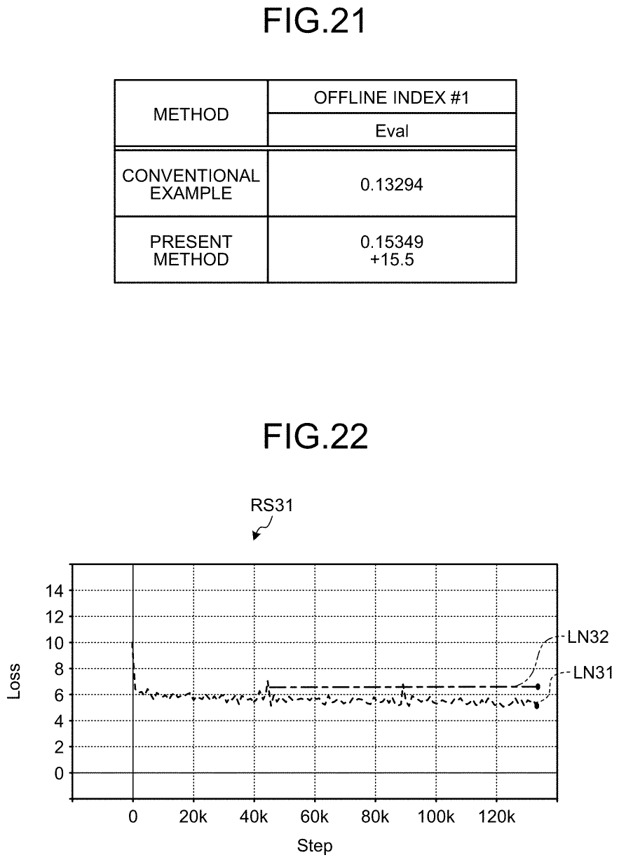

In FIG. 21 is illustrated the third experimental result obtained as a result of using the dataset illustrated in FIG. 21. FIG. 21 is a diagram illustrating a list indicating the third experimental result. In FIG. 21, “offline index #1” represents the reference index for model accuracy.

When the action data of the user was input to a model using the offline index #1 and when the top five books in descending order of scores output by the model were extracted from the target books, the experiment result illustrated in FIG. 21 indicates the percentage of the books that were actually browsed by the user (for example, the books whose contents were actually read from the corresponding pages).

As illustrated in FIG. 21, regarding the conventional example, the degree of accuracy of “0.13294” was achieved as a result of using the data for evaluation. On the other hand, in the present method, the degree of accuracy of “0.15349” was achieved as a result of using the data for evaluation. In this way, when the degrees of accuracy achieved as a result of using the data for evaluation were compared, the present method was seen to have an enhancement (improvement) of “15.5%” in the degree of accuracy over the conventional example.

Given below is the explanation about the points related to the experimental result. Firstly, explained below with reference to FIG. 22 is the relationship between the steps and the losses. FIG. 22 is a diagram illustrating a graph related to the third experimental result. In a graph RS31 illustrated in FIG. 22, the horizontal axis represents the steps and the vertical axis represents the losses.

In the graph RS31 illustrated in FIG. 22, lines LN31 and LN32 indicate the relationship between the values and the steps. The line LN31 indicates the relationship between “training loss values” (for example, the loss values during the training) and the steps in the present method. The line LN32 indicates the relationship between “eval loss values” (for example, the loss values during the evaluation) and the steps in the present method. As illustrated in FIG. 22, in the present method, the loss values converge among substantially fixed values.

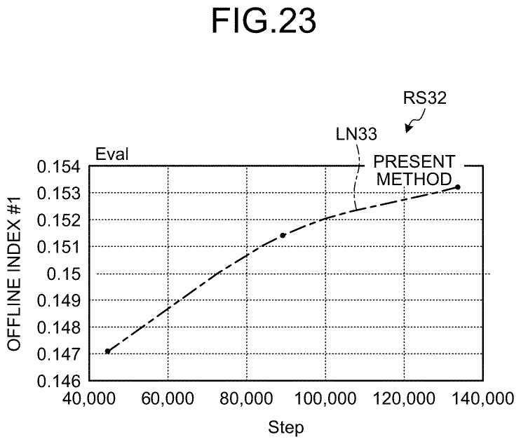

Explained below with reference to FIG. 23 is the relationship between the steps and the degrees of accuracy. FIG. 23 is a diagram illustrating a graph related to the third experimental result. In a graph RS32 illustrated in FIG. 23, the horizontal axis represents the steps and the vertical axis represents the degrees of accuracy.

In the graph RS32 illustrated in FIG. 23, a line LN33 indicates the relationship between the degrees of accuracy and the steps in the respective methods. The line LN33 indicates the relationship between the degrees of accuracy and the steps in the present method. As illustrated in FIG. 23, in the present method, the degree of accuracy sees an enhancement up to “0.15349”.

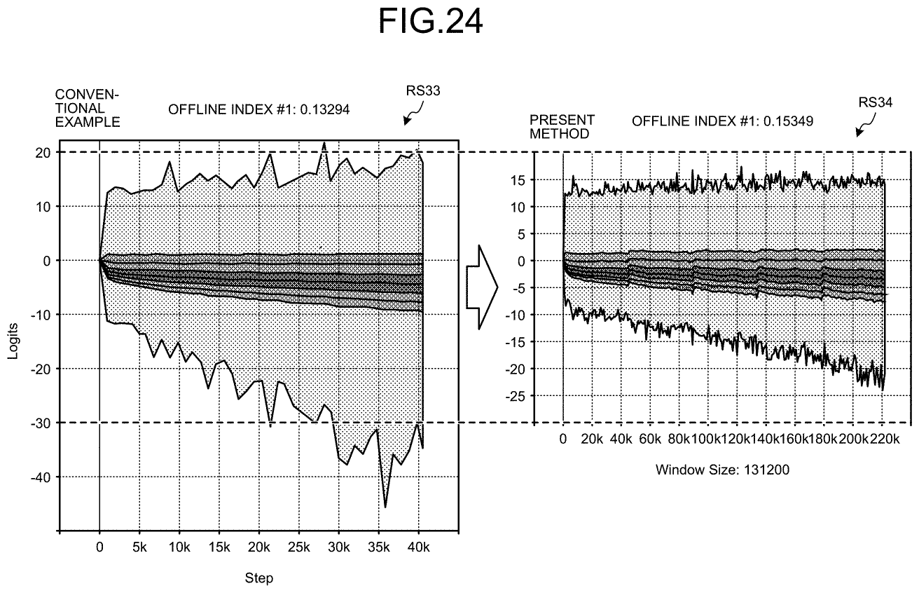

Explained below with reference to FIG. 24 is the relationship between the steps and the weights. FIG. 24 is a diagram illustrating a graph related to the third experimental result. In graphs RS33 and RS34 illustrated in FIG. 24, the horizontal axis represents the steps and the vertical axis represents Logits (the outputs of the model). Moreover, in FIG. 24, “Window Size: 131200” indicates the time window when the third experimental result was obtained.

The graph RS33 illustrated in FIG. 24 indicates the relationship between the outputs of the model and the steps in the conventional example. In the graph RS33, the waveforms represent the variability in the outputs of the model in the form of standard deviation. In the graph RS33, the nine waveforms are identical to the waveforms in the graph RS13 illustrated in FIG. 15. Hence, their detailed explanation is not given again. The graph RS34 illustrated in FIG. 24 indicates the relationship between the outputs of the model and the steps in the present method. In the graph RS34, the waveforms represent the variability in the outputs of the model in the form of standard deviation. In the graph RS34, the nine waveforms are identical to the waveforms in the graph RS14 illustrated in FIG. 15. Hence, their detailed explanation is not given again.

As illustrated in FIG. 24, in the present method, there is a decrease in the variability in Logits (the outputs of the model) as compared to the conventional example. As a result of a decrease in Logits (the outputs of the model), the weight value also decreases. Hence, in the present method, there is a decrease in the variability in the weight.

[8-4. Fourth Experimental Result]

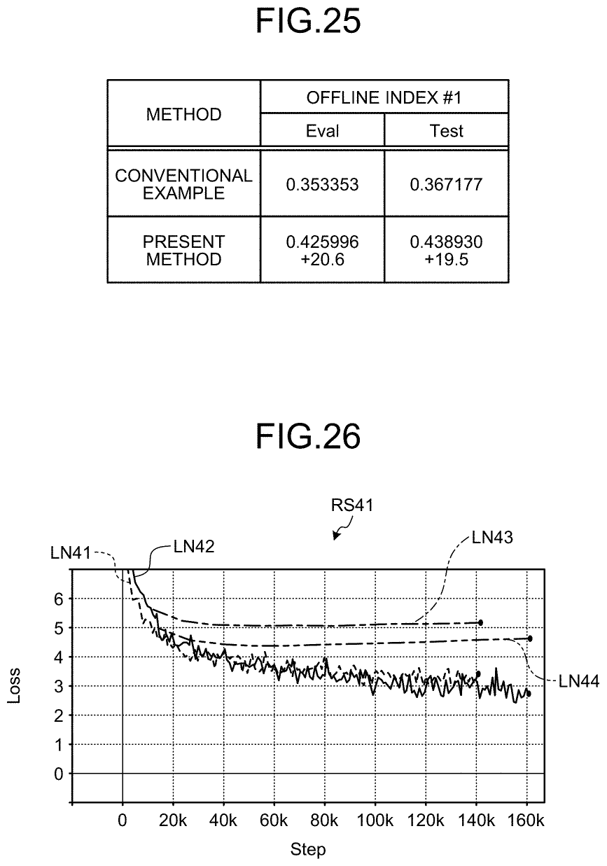

Explained below with reference to FIGS. 25 to 28 is the fourth experimental result. Regarding the identical points to the first experimental result, the second experimental result, and the third explanation result; the explanation is not given again. The fourth experimental result is the experimental result obtained when a model that recommends information in a known search service, such as what is called a knowledge community, (for example, information about answered questions) in response to a user action (hereinafter, called a “fourth model”) was generated, and the degree of accuracy of that model (the fourth model) was measured. In the fourth model, when action data of the user is input, for example, the scores of a large number of sets of intended information, such as tens of thousands of sets of information (also called “target information”) are output. For example, the fourth experimental result was obtained using the dataset (Trial A) illustrated in FIG. 11.

FIG. 25 is a diagram illustrating a list indicating the fourth experimental result. In FIG. 25, “offline index #1” represents the reference index for model accuracy.

When the action data of the user was input to a model using the offline index #1 and when the top five sets of information in descending order of scores output by the model were extracted from the target sets of information, the experiment result illustrated in FIG. 25 indicates the percentage of the sets of information that were actually browsed by the user (for example, the contents that were actually read from the corresponding pages).

As illustrated in FIG. 25, regarding the conventional example, the degree of accuracy of “0.353353” was achieved as a result of using the data for evaluation. On the other hand, regarding the present method, the degree of accuracy of “0.425996” was achieved as a result of using the data for evaluation. When the degrees of accuracy achieved as a result of using the data for evaluation were compared, the present method was seen to have an enhancement (improvement) of “20.6%” in the degree of accuracy over the conventional example.

Moreover, regarding the conventional example, the degree of accuracy of “0.367177” was achieved as a result of using the data for testing. On the other hand, regarding the present method, the degree of accuracy of “0.438930” was achieved as a result of using the data for testing. When the degrees of accuracy achieved as a result of using the data for testing were compared, the present method was seen to have an enhancement (improvement) of “19.5%” in the degree of accuracy over the conventional example.

Given below is the explanation about the points related to the experimental result. Firstly, explained below with reference to FIG. 26 is the relationship between the steps and the losses. FIG. 26 is a diagram illustrating a graph related to the fourth experimental result. In a graph RS41 illustrated in FIG. 26, the horizontal axis represents the steps and the vertical axis represents the losses.

In the graph RS41 illustrated in FIG. 26, lines LN41 to LN44 indicate the relationship between the values and the steps. The line LN41 indicates the relationship between “training loss values” (for example, the loss values during the training) and the steps in the conventional example. The line LN42 indicates the relationship between “training loss values” (for example, the loss values during the training) and the steps in the present method. The line LN43 indicates the relationship between “eval loss values” (for example, the loss values during the evaluation) and the steps in the conventional example. The line LN44 indicates the relationship between “eval loss values” (for example, the loss values during the evaluation) and the steps in the present method. As illustrated in FIG. 26, the loss values in the present method are held down to a lower level as compared to the loss values in the conventional example.

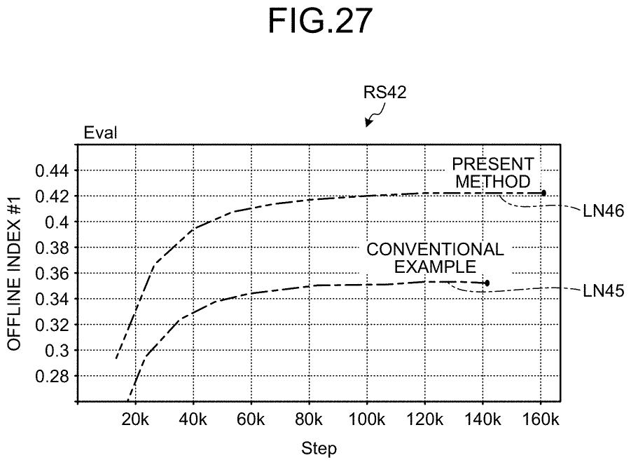

Explained below with reference to FIG. 27 is the relationship between the steps and the degrees of accuracy. FIG. 27 is a diagram illustrating a graph related to the fourth experimental result. In a graph RS42 illustrated in FIG. 27, the horizontal axis represents the steps and the vertical axis represents the degrees of accuracy.

In the graph RS42 illustrated in FIG. 27, lines LN45 and LN46 indicate the relationship between the degrees of accuracy and the steps in the respective methods. The line LN45 indicates the relationship between the degrees of accuracy and the steps in the conventional example. The line LN46 indicates the relationship between the degrees of accuracy and the steps in the present method. As illustrated in FIG. 27, there is an enhancement in the degrees of accuracy in the present method as compared to the conventional example.

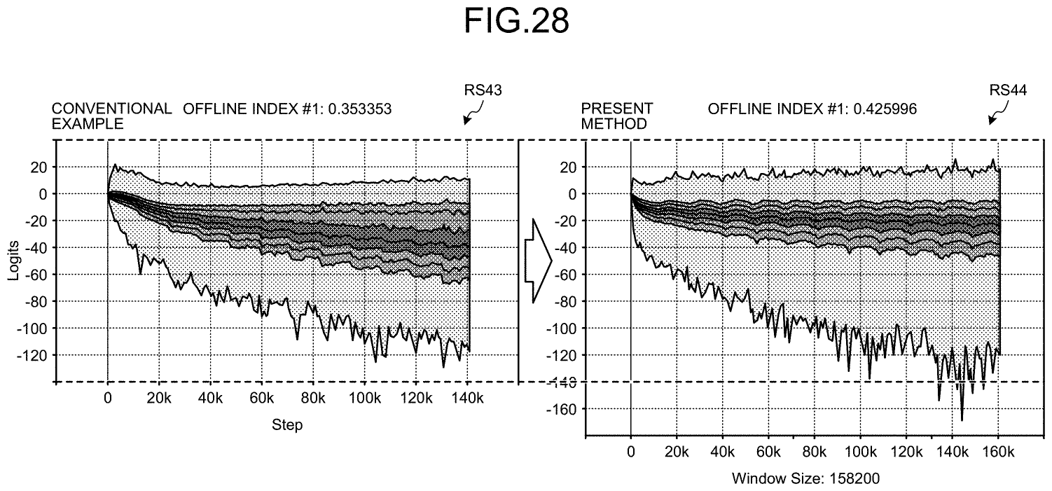

Explained below with reference to FIG. 28 is the relationship between the steps and the weights. FIG. 28 is a diagram illustrating graphs related to the fourth experimental result. In graphs RS43 and RS44 illustrated in FIG. 28, the horizontal axis represents the steps and the vertical axis represents Logits (the outputs of the model). Moreover, in FIG. 28, “Window Size: 131200” indicates the time window when the fourth experimental result was obtained.

The graph RS43 illustrated in FIG. 28 indicates the relationship between the outputs of the model and the steps in the conventional example. In the graph RS43, the waveforms represent the variability in the outputs of the model in the form of standard deviation. In the graph RS43, the nine waveforms are identical to the waveforms in the graph RS13 illustrated in FIG. 15. Hence, their detailed explanation is not given again. The graph RS44 illustrated in FIG. 28 indicates the relationship between the outputs of the model and the steps in the present method. In the graph RS44, the waveforms represent the variability in the outputs of the model in the form of standard deviation. In the graph RS44, the nine waveforms are identical to the waveforms in the graph RS14 illustrated in FIG. 15. Hence, their detailed explanation is not given again.

As illustrated in FIG. 28, in the present method, there is a decrease in the variability in Logits (the outputs of the model) as compared to the conventional example. As a result of a decrease in Logits (the outputs of the model), the weight value also decreases. Hence, in the present method, there is a decrease in the variability in the weight.

[8-5. Fifth Experimental Result]

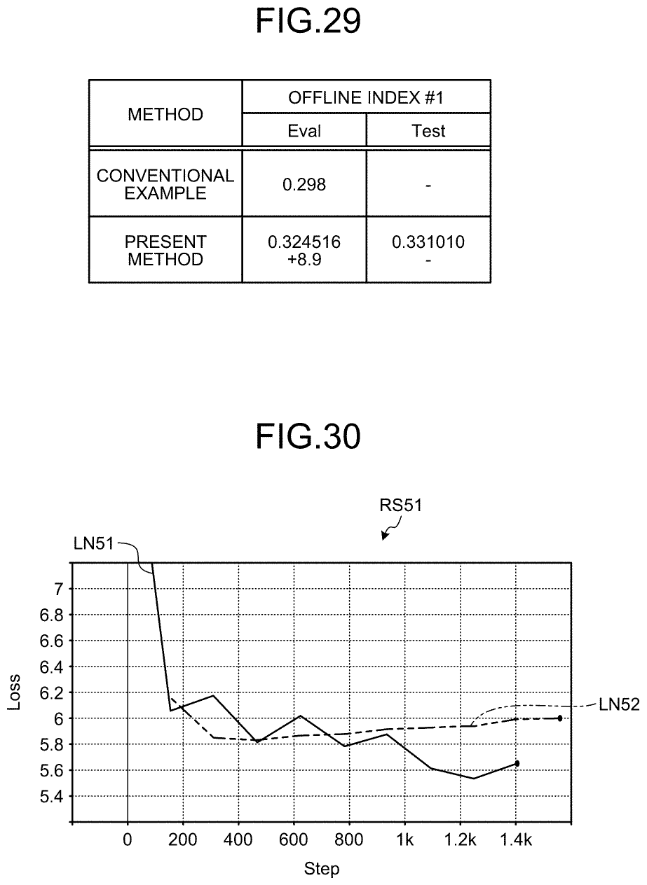

Explained below with reference to FIGS. 29 to 32 is the result of the fifth experimental result. Regarding the identical points to the first experimental result, the second experimental result, the third explanation result, and the fourth experimental result; the explanation is not given again. The fifth experimental result is the experimental result obtained when a model that recommends information of a service for providing information such as coupons or sale (for example, recommends coupons) in response to a user action (hereinafter, called a “fifth model”) was generated, and the degree of accuracy of that model (the fifth model) was measured. In the fifth model, when action data of the user is input, for example, the scores of a large number of sets of intended information, such as tens of thousands of sets of information (also called “target information”) are output. For example, the fifth experimental result was obtained using the dataset (Trial A) illustrated in FIG. 11.

FIG. 29 is a diagram illustrating a list indicating the fifth experimental result. In FIG. 29, “offline index #1” represents the reference index for model accuracy.

When the action data of the user was input to a model using the offline index #1 and when the top five sets of information in descending order of scores output by the model were extracted from the target sets of information, the experiment result illustrated in FIG. 29 indicates the percentage of the sets of information that were actually browsed by the user (for example, the contents that were actually read from the corresponding pages).

As illustrated in FIG. 29, regarding the conventional example, the degree of accuracy of “0.298” was achieved as a result of using the data for evaluation. On the other hand, regarding the present method, the degree of accuracy of “0.324516” was achieved as a result of using the data for evaluation. When the degrees of accuracy achieved as a result of using the data for evaluation were compared, the present method was seen to have an enhancement (improvement) of “8.9%” in the degree of accuracy over the conventional example.

Moreover, regarding the present method, the degree of accuracy of “0.331010” was achieved as a result of using the data for testing. Thus, in the present method, when the data for testing was used, enhancement in the degree of accuracy was seen as compared to the case in which the data for evaluation was used.

Given below is the explanation about the points related to the experimental result. Firstly, explained below with reference to FIG. 30 is the relationship between the steps and the losses. FIG. 30 is a diagram illustrating a graph related to the fifth experimental result. In a graph RS51 illustrated in FIG. 30, the horizontal axis represents the steps and the vertical axis represents the losses.

In the graph RS51 illustrated in FIG. 30, lines LN51 and LN52 indicate the relationship between the values and the steps. The line LN51 indicates the relationship between “eval loss values” (for example, the loss values during the evaluation) and the steps in the conventional example. The line LN52 indicates the relationship between “eval loss values” (for example, the loss values during the evaluation) and the steps in the conventional example. As illustrated in FIG. 30, the loss values in the present method are held down to a lower level as compared to the loss values in the conventional example.

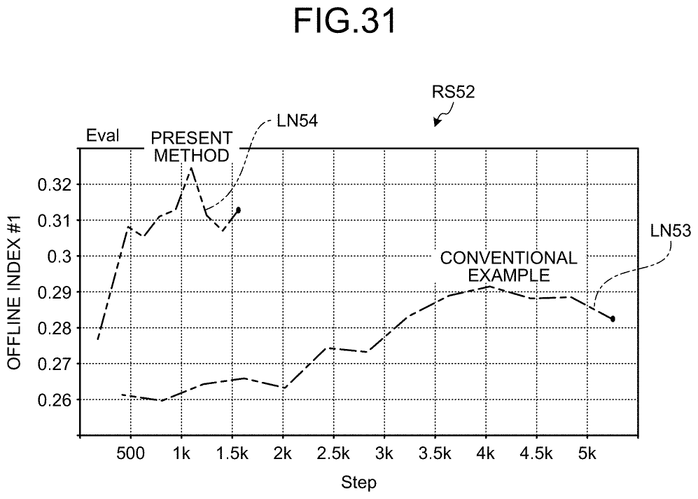

Explained below with reference to FIG. 31 is the relationship between the steps and the degrees of accuracy. FIG. 31 is a diagram illustrating a graph related to the fifth experimental result. In a graph RS52 illustrated in FIG. 31, the horizontal axis represents the steps and the vertical axis represents the degrees of accuracy.

In the graph RS52 illustrated in FIG. 31, lines LN53 and LN54 indicate the relationship between the degrees of accuracy and the steps in the respective methods. The line LN53 indicates the relationship between the degrees of accuracy and the steps in the conventional example. The line LN54 indicates the relationship between the degrees of accuracy and the steps in the present method. As illustrated in FIG. 31, in the present method, not only a high degree of accuracy is achieved at an early stage, but there is also an enhancement in the degrees of accuracy as compared to the conventional example.

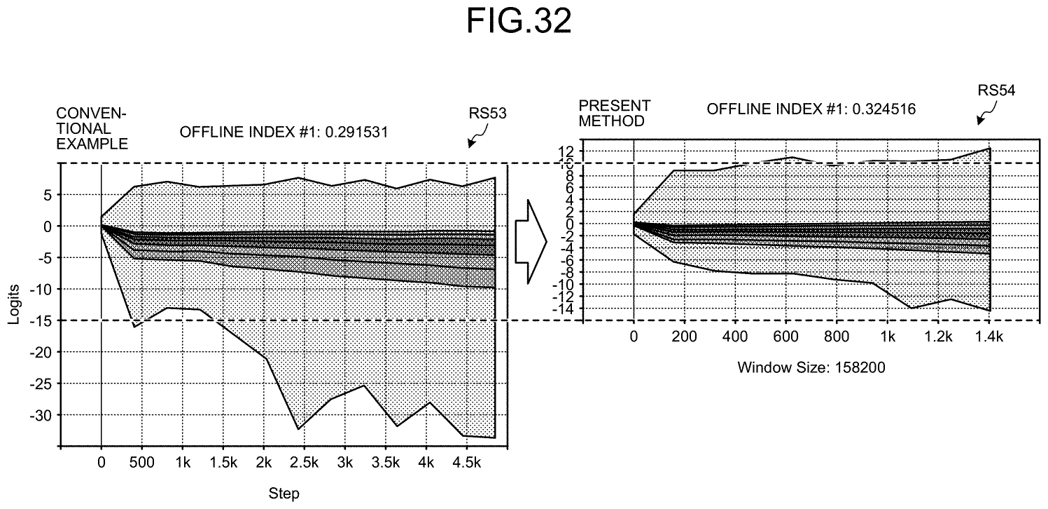

Explained below with reference to FIG. 32 is the relationship between the steps and the weights. FIG. 32 is a diagram illustrating graphs related to the fifth experimental result. In graphs RS53 and RS54 illustrated in FIG. 32, the horizontal axis represents the steps and the vertical axis represents Logits (the outputs of the model). Moreover, in FIG. 32, “Window Size: 131200” indicates the time window when the fifth experimental result was obtained.

The graph RS53 illustrated in FIG. 32 indicates the relationship between the outputs of the model and the steps in the conventional example. In the graph RS53, the waveforms represent the variability in the outputs of the model in the form of standard deviation. In the graph RS53, the nine waveforms are identical to the waveforms in the graph RS13 illustrated in FIG. 15. Hence, their detailed explanation is not given again. The graph RS54 illustrated in FIG. 32 indicates the relationship between the outputs of the model and the steps in the present method. In the graph RS54, the waveforms represent the variability in the outputs of the model in the form of standard deviation. In the graph RS54, the nine waveforms are identical to the waveforms in the graph RS14 illustrated in FIG. 15. Hence, their detailed explanation is not given again.

As illustrated in FIG. 32, in the present method, there is a decrease in the variability in Logits (the outputs of the model) as compared to the conventional example. As a result of a decrease in Logits (the outputs of the model), the weight value also decreases. Hence, in the present method, there is a decrease in the variability in the weight.

[8-6. Sixth Experimental Result]

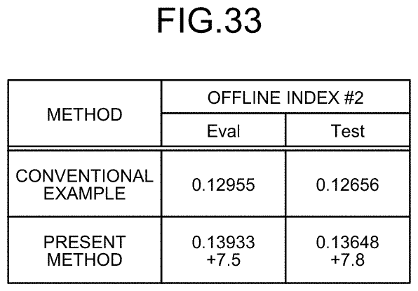

Explained below with reference to FIGS. 33 to 35 is the result of the sixth experimental result. Regarding the identical points to the first experimental result to the fifth experimental result, the explanation is not given again. The sixth experimental result is the experimental result obtained when a model that, in response to a user action, recommends accommodation facilities to a user who is using a travel service for the first time (hereinafter, called a “sixth model”) was generated, and the degree of accuracy of that model (the sixth model) was measured. In the sixth model, when action data of the user is input, for example, the scores of a large number of intended accommodation facilities, such as tens of thousands of accommodation facilities (also called “target accommodation facilities”) are output. For example, the sixth experimental result was obtained using the dataset (Trial A) illustrated in FIG. 11.

FIG. 33 is a diagram illustrating a list indicating the sixth experimental result. In FIG. 33, “offline index #2” represents the reference index for model accuracy.

In the experimental result illustrated in FIG. 33, in the list of descending order of scores output by the model, the offline index #2 indicates the average of the inverse number of the rank of the initially-appearing accommodation facility that the user actually browsed.

As illustrated in FIG. 33, regarding the conventional example, the degree of accuracy of “0.12955” was achieved as a result of using the data for evaluation. On the other hand, regarding the present method, the degree of accuracy of “0.13933” was achieved as a result of using the data for evaluation. When the degrees of accuracy achieved as a result of using the data for evaluation were compared, the present method was seen to have an enhancement (improvement) of “7.5%” in the degree of accuracy over the conventional example.

Moreover, regarding the conventional example, the degree of accuracy of “0.12656” was achieved as a result of using the data for testing. On the other hand, regarding the present method, the degree of accuracy of “0.13648” was achieved as a result of using the data for testing. When the degrees of accuracy achieved as a result of using the data for testing were compared, the present method was seen to have an enhancement (improvement) of “7.8%” in the degree of accuracy over the conventional example.

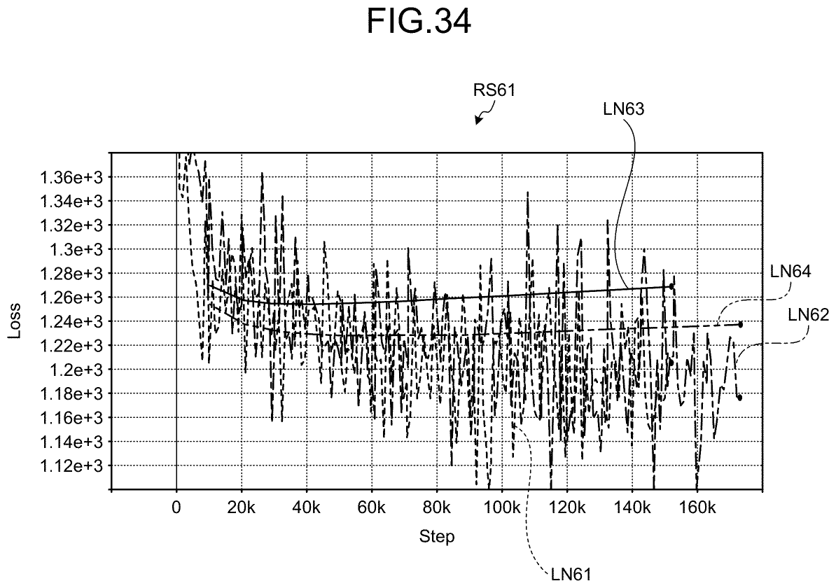

Given below is the explanation about the points related to the experimental result. Firstly, explained below with reference to FIG. 34 is the relationship between the steps and the losses. FIG. 34 is a diagram illustrating a graph related to the sixth experimental result. In a graph RS61 illustrated in FIG. 34, the horizontal axis represents the steps and the vertical axis represents the losses.

In the graph RS61 illustrated in FIG. 34, lines LN61 to LN64 indicate the relationship between the values and the steps. The line LN61 indicates the relationship between “training loss values” (for example, the loss values during the training) and the steps in the conventional example. The line LN62 indicates the relationship between “training loss values” (for example, the loss values during the training) and the steps in the present method. The line LN63 indicates the relationship between “eval loss values” (for example, the loss values during the evaluation) and the steps in the conventional example. The line LN64 indicates the relationship between “eval loss values” (for example, the loss values during the evaluation) and the steps in the present method. As illustrated in FIG. 34, the loss values in the present method are held down to a lower level as compared to the loss values in the conventional example.

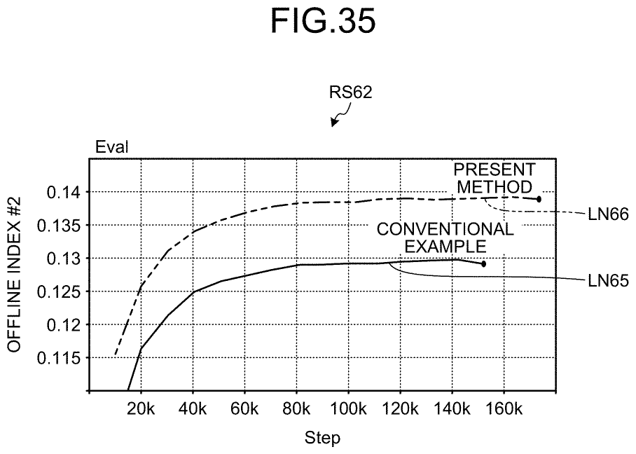

Explained below with reference to FIG. 35 is the relationship between the steps and the degrees of accuracy. FIG. 35 is a diagram illustrating a graph related to the sixth experimental result. In a graph RS62 illustrated in FIG. 35, the horizontal axis represents the steps and the vertical axis represents the degrees of accuracy.

In the graph RS62 illustrated in FIG. 35, lines LN65 and LN66 indicate the relationship between the degrees of accuracy and the steps in the respective methods. The line LN65 indicates the relationship between the degrees of accuracy and the steps in the conventional example. The line LN66 indicates the relationship between the degrees of accuracy and the steps in the present method. As illustrated in FIG. 35, in the present method, there is an enhancement in the degrees of accuracy as compared to the conventional example.

[8-7. Other Experimental Results]

Although the detailed experimental result is not presented herein, when the third operation related to batch normalization was applied, it was possible to achieve enhancement in the degree of accuracy by a certain percentage.

### 9. Modification Example

In the explanation given above, the examples of the information processing were explained. However, the embodiment is not limited by that explanation. Given below is the explanation about modification examples of a information processing.

[9-1. Device Configuration]

In the embodiment described above, the information processing system 1 includes the information processing apparatus 10 that generates generation indexes, and includes the model generation server 2 that generates models according to the generation indexes. However, the embodiment is not limited by that example. Alternatively, for example, the information processing apparatus 10 can be configured to have the functions of the model generation server 2. Still alternatively, the functions implemented by the information processing apparatus 10 can be provided in the terminal device 3. In that case, the terminal device 3 automatically generates generation indexes and automatically generates models using the model generation server 2.

[9-2. Other Information]

Of the processes described in the embodiments, all or part of the processes explained as being performed automatically can be performed manually. Similarly, all or part of the processes explained as being performed manually can be performed automatically by a known method. The processing procedures, the control procedures, specific names, various data, and information including parameters described in the embodiments or illustrated in the drawings can be changed as required unless otherwise specified. For example, a variety of information illustrated in the drawings is not limited to that information.

The constituent elements of the device illustrated in the drawings are merely conceptual, and need not be physically configured as illustrated. The constituent elements, as a whole or in part, can be separated or integrated either functionally or physically based on various types of loads or use conditions.

Moreover, the embodiments can be appropriately combined without causing any contradictions in the operation details.

[9-3. Program]

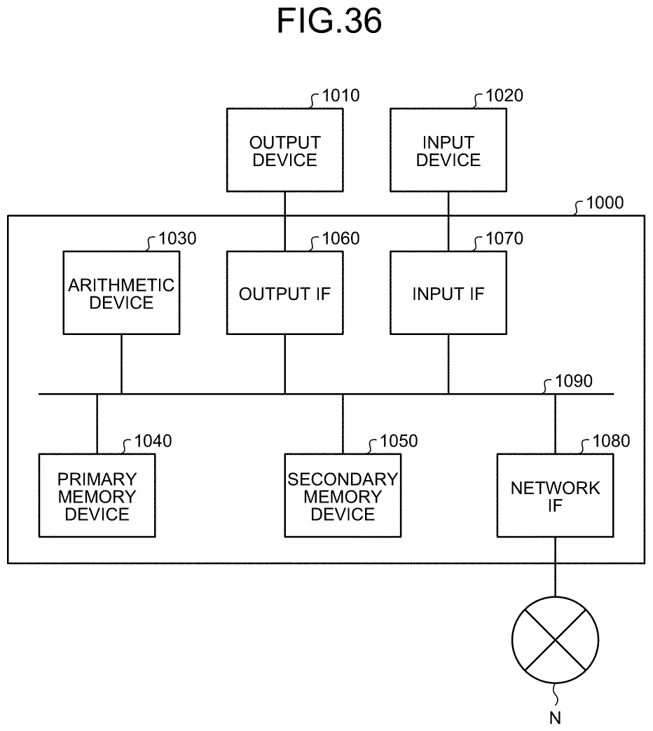

The information processing apparatus 10 according to the embodiment is implemented using, for example, a computer 1000 having a configuration as illustrated in FIG. 36. FIG. 36 is a diagram illustrating an exemplary hardware configuration. The computer 1000 is connected to an output device 1010 and the input device 1020; and includes an arithmetic device 1030, a primary memory device 1040, a secondary memory device 1050, an output IF (Interface) 1060, an input IF 1070, and a network IF 1080 that are connected to each other by a bus 1090.

The arithmetic device 1030 runs based on the programs stored in the primary memory device 1040 or the secondary memory device 1050, or runs based on the programs read from the input device 1020; and performs various operations. The primary memory device 1040 is used to primarily store the data used by the arithmetic device 1030 in various arithmetic operations. The secondary memory device 1050 is used to store data used by the arithmetic device 1030 in various arithmetic operations, and to register various databases. The secondary memory device 1050 is implemented using a ROM (Read Only Memory), an HDD, or a flash memory.

The output IF 1060 is an interface for sending the target information for output to the output device 1010 such as a monitor or a printer that outputs a variety of information. For example, the output IF 1060 is implemented using a connector conforming to a standard such as USB (Universal Serial Bus), or DVI (Digital Visual Interface), or HDMA (registered trademark) (High Definition Multimedia Interface). The input IF 1070 is an interface for receiving information from a variety of input devices 1020 such as a mouse, a keyboard, and a scanner; and is implemented using, for example, a USB.

Alternatively, the input device 1020 can be a device that reads information from, for example, an optical recording medium such as a CD (Compact Disc), a DVD (Digital Versatile Disc), or a PD (Phase change rewritable Disk); a magneto-optical recording medium such as an MO (Magneto-Optical disk); a tape medium; a magnetic recording medium; or a semiconductor memory. Still alternatively, the input device 1020 can be an external memory medium such as a USB memory.

The network IF 1080 receives data from other devices via the network N and sends it to the arithmetic device 1030; and sends data generated by the arithmetic device 1030 to other devices via the network N.

The arithmetic device 1030 controls the output device 1010 and the input device 1020 via the output IF 1060 and the input IF 1070, respectively. For example, the arithmetic device 1030 loads programs from the input device 1020 or the secondary memory device 1050 into the primary memory device 1040, and executes the loaded programs.

For example, when the computer 1000 functions as the information processing apparatus 10, the arithmetic device 1030 of the computer 1000 executes programs loaded in the primary memory device 1040 and implements the functions of the control unit 40.

### 10. Effect

As explained above, the information processing apparatus 10 includes an obtaining unit (the obtaining unit 41 according to the embodiment) that obtains datasets of training data to be used for the training of a model, and includes a generating unit (the generating unit 45 according to the embodiment) that generates a model in such a way that there is a decrease in the variability in the weight. For example, the information processing apparatus 10 generates a training data group from the datasets in such a way that there is a decrease in the weight of the model, and generates a model using the training data group. As a result, a model in which the variability in the weight is held down is generated. In an experimental result that was obtained in the case of using a model generated to have less variability in the weight, enhancement was seen in the degree of accuracy of the model. Thus, the information processing apparatus 10 enables achieving enhancement in the degree of accuracy of a model.

Moreover, the generating unit generates a model in such a way that there is a decrease in the standard deviation or the dispersion of the weight. In an experimental result that was obtained in the case of using a model generated to have less variability in the standard deviation or the dispersion of the weight, enhancement was seen in the degree of accuracy of the model. Thus, the information processing apparatus 10 enables achieving enhancement in the degree of accuracy of a model.

Furthermore, the generating unit generates a model using post-conversion training data obtained by converting the training data in such a way that there is a decrease in the variability in the weight of the model. Thus, in the information processing apparatus 10, the post-conversion training data, which is obtained by conversion of the training data in such a way that there is a decrease in the variability in the weight of the model, is used as the input for the model. That enables achieving enhancement in the degree of accuracy of the model.

Moreover, the generating unit generates a model using post-conversion training data obtained by normalization of the training data. Thus, in the information processing apparatus 10, the post-conversion training data, which is obtained by normalization of the training data, is used as the input for the model. That enables achieving enhancement in the degree of accuracy of the model.

Furthermore, the generating unit generates a model using post-conversion training data obtained by converting the training data into vectors. Thus, in the information processing apparatus 10, the post-conversion training data, which is obtained by converting the training data into vectors, is used as the input for the model. That enables achieving enhancement in the degree of accuracy of the model.

Moreover, the generating unit converts the training data into post-conversion training data. Thus, in the information processing apparatus 10, post-conversion training data is generated by conversion of the training data, and the post-conversion training data is used as the input for the model. That enables achieving enhancement in the degree of accuracy of the model.

Furthermore, when the training data points to an item related to a numerical value, the generating unit generates post-conversion training data by normalizing the training data. Thus, in the information processing apparatus 10, when the training data points to an item related to a numerical value, the post-conversion training data is generated by normalizing the training data. With that, data conversion can be appropriately performed according to the type of the data.

Moreover, the generating unit uses a predetermined conversion function meant for normalizing the training data, and generates post-conversion training data as a result of normalizing the training data. Thus, in the information processing apparatus 10, as a result of using a predetermined conversion function for normalizing the training data, it becomes possible to appropriately normalize the data.

Furthermore, when the training data points to an item related to a category, the generating unit converts the training data into vectors and generates post-conversion training data. Thus, in the information processing apparatus 10, when the training data points to an item related to a category, the training data is converted into vectors and post-conversion generation data is generated. With that, data conversion can be appropriately performed according to the type of the data.

Moreover, the generating unit uses a vector conversion model meant for embedding the training data, and generates post-conversion training data by converting the training data into vectors. As a result, in the information processing apparatus 10, as a result of using a vector conversion model meant for embedding the training data, it becomes possible to perform data embedding in an appropriate manner.

Furthermore, the information processing apparatus 10 includes a learning unit (the learning unit 42 according to the embodiment) that generates a vector conversion model by performing a training operation. Thus, in the information processing apparatus 10, a vector conversion model is generated by performing a training operation. With that, it becomes possible to generate a model for appropriate data embedding.

Moreover, the learning unit generates a vector conversion model trained in the features of the training data. Thus, in the information processing apparatus 10, as a result of generating a vector conversion model trained in the features of the training data, it becomes possible to generate a model for appropriate data embedding.

Furthermore, the learning unit generates a vector conversion model in such a way that there is a decrease in the variability in the distribution of the vectors output from the vector conversion model. Thus, in the information processing apparatus 10, since post-conversion training data having less variability can be generated using a vector conversion model, it becomes possible to enhance the degree of accuracy of the model.

Moreover, the generating unit generates a model using a partial data group from a dataset based on a predetermined range. Thus, in the information processing apparatus 10, the input for the mode can be adjusted by partitioning a dataset according to a predetermined range. That enables achieving reduction in the variability in the weight of the model, and achieving enhancement in the degree of accuracy of the model.

Furthermore, the generating unit generates a model using a partial data group generated from a dataset, in which sets of training data are associated to time, based on a time window indicating a predetermined time range. Thus, in the information processing apparatus 10, the input for the model can be adjusted by partitioning a dataset in which sets of training data are associated to time. That enables achieving reduction in the variability in the weight of the model, and achieving enhancement in the degree of accuracy of the model.

Moreover, the generating unit generates a model using a partial data group in which a plurality of sets of partial data overlappingly contains a single set of training data. Thus, in the information processing apparatus 10, the width for shifting the time window can be adjusted to be shorter than the time window. Hence, it becomes further possible to learn the features of the data, thereby enabling achieving enhancement in the degree of accuracy of the model.

Furthermore, the generating unit generates a model, with the data corresponding to each partial data group serving as the data to be input to the model. Thus, in the information processing apparatus 10, the data that corresponds to each partial data group having the range adjusted is used as the data to be input to be model. That enables achieving reduction in the variability in the weight of the model, and achieving enhancement in the degree of accuracy of the model.

Moreover, the generating unit generates a model using batch normalization. Thus, in the information processing apparatus 10, the inter-layer impact of the model can be held down, thereby enabling achieving reduction in the variability in the weight of the model. Hence, it becomes possible to enhance the degree of accuracy of the model.

Furthermore, the generating unit generates a model using batch normalization in which the input for each layer of the model is normalized. Thus, in the information processing apparatus 10, the input for each layer of the model is normalized. That enables achieving reduction in the variability in the weight of the model, and achieving enhancement in the degree of accuracy of the model.

Moreover, the generating unit generates a model by sending the data to be used in model generation to an external model generation server (“the model generation server 2” according to the embodiment); requesting the model generation server to learn the model; and receiving the model learnt by the model generation server from the model generation server. As a result, the information processing apparatus 10 can train a model generation server in a model and can receive that model. Thus, the model can be generated in an appropriate manner. For example, the information processing apparatus 10 can send post-conversion training data to an external device for generating models, such as the model generation server 2, can request the external device to learn a model using the post-conversion training data, and thus can generate a model in an appropriate manner.

Herein, although the description is given about the embodiment of the application concerned, the technical scope of the present invention is not limited to the embodiment described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, a delivery unit can be read as a delivery device or a delivery circuit.

### EXPLANATIONS OF LETTERS OR NUMERALS

1 information processing system
2 model generation server
3 terminal device
10 information processing apparatus
20 communication unit
30 memory unit
40 control unit
41 obtaining unit
42 learning unit
43 deciding unit
44 receiving unit
45 generating unit
46 providing unit

1. An information processing apparatus comprising:
an obtaining unit that obtains a dataset of training data to be used for training of a model; and
a generating unit that uses the dataset and generates a model in such a way that there is a decrease in variability in weight.

2. The information processing apparatus according to claim 1, wherein the generating unit generates the model in such a way that there is a decrease in standard deviation or dispersion of the weight.

3. The information processing apparatus according to claim 1, wherein the generating unit generates the model using post-conversion training data obtained by conversion in such a way that there is a decrease in variability in the weight of the model.

4. The information processing apparatus according to claim 3, wherein the generating unit generates the model using the post-conversion training data obtained by normalization of the training data.

5. The information processing apparatus according to claim 3, wherein the generating unit generates the model using the post-conversion training data obtained by converting the training data into vectors.

6. The information processing apparatus according to claim 3, wherein the generating unit converts the training data into the post-conversion training data.

7. The information processing apparatus according to claim 6, wherein, when the training data points to an item related to a numerical value, the generating unit normalizes the training data and generates the post-conversion training data.

8. The information processing apparatus according to claim 7, wherein, using a predetermined conversion function for normalizing the training data, the generating unit generates the post-conversion training data by normalizing the training data.

9. The information processing apparatus according to claim 6, wherein, when the training data points to an item related to a category, the generating unit converts the training data into vectors and generates the post-conversion training data.

10. The information processing apparatus according to claim 9, wherein, using a vector conversion model for embedding the training data, the generating unit generates the post-conversion training data by converting the training data into vectors.

11. The information processing apparatus according to claim 10, further comprising a learning unit that generates the vector conversion model by performing a training operation.

12. The information processing apparatus according to claim 11, wherein the learning unit generates the vector conversion model that is trained in features of the training data.

13. The information processing apparatus according to claim 12, wherein the learning unit generates the vector conversion model in such a way that there is a decrease in variability in distribution of vectors output by the vector conversion model.

14. The information processing apparatus according to claim 1, wherein the generating unit generates the model using a partial data group generated from the dataset based on a predetermined range.

15. The information processing apparatus according to claim 14, wherein the generating unit generates the model using the partial data group that is generated from the dataset, in which sets of training data are associated to time, based on a time window indicating a predetermined time range.

16. The information processing apparatus according to claim 15, wherein the generating unit generates the model using the partial data group in which a plurality of sets of partial data overlappingly contains a single set of training data.

17. The information processing apparatus according to claim 14, wherein the generating unit generates the model, with data corresponding to each of the partial data group serving as data to be input to a model.

18. The information processing apparatus according to claim 1, wherein the generating unit generates the model using batch normalization.

19. The information processing apparatus according to claim 18, wherein the generating unit generates the model using the batch normalization in which input of each layer of the model is normalized.

20. The information processing apparatus according to claim 1, wherein the generating unit generates the model by
sending data to be used in generation of the model to an external model generation server,
requesting the model generation server to learn the model, and
receiving the model learnt by the model generation server from the model generation server.

21. An information processing method implemented in an information processing apparatus, comprising:
obtaining a dataset of training data to be used for training of a model; and
using the dataset and generating a model in such a way that there is a decrease in variability in weight.

22. A non-transitory computer-readable storage medium having stored therein an information processing program that causes a computer to execute:
obtaining a dataset of training data to be used for training of a model; and
using the dataset and generating a model in such a way that there is a decrease in variability in weight.
